(19) United States
(12) Patent Application Publication
(10) Pub. No.: US 2014/0364237 A1
(43) Pub. Date: Dec. 11, 2014

(54) MULTIPLAYER NETWORK GAME NOTIFICATIONS

(71) Applicants: Matthew Robert Read, Encinitas, CA (US); Chandra Janakiraman, Carlsbad, CA (US); Mark Turmell, Encinitas, CA (US)

(72) Inventors: Matthew Robert Read, Encinitas, CA (US); Chandra Janakiraman, Carlsbad, CA (US); Mark Turmell, Encinitas, CA (US)

(21) Appl. No.: 14/271,849

(22) Filed: May 7, 2014

Related U.S. Application Data
(60) Provisional application No. 61/832,317, filed on Jun. 7, 2013.

(51) Int. Cl. A63F 13/5375; A63F 13/335; A63F 13/87

(52) U.S. Cl. CPC A63F 13/5375; A63F 13/87; A63F 13/335
USPC 463/40

(57) ABSTRACT

A game system may receive an attack by a first player against a second player. The game system may notify a third player of the attack and provide the third player the option to intervene. The game system may notify the second player of the attack and provide the second player the option to mitigate damage from the attack. The game system may notify the third player based on their status as guildmates, neighbors, or connection in a social network with the first player or the second player. The option to intervene or mitigate may be available for a limited period of time. Responding to the attack may add units to the battle, reduce damage taken, or generate other benefits.

### CLAIM OF PRIORITY UNDER 35 U.S.C. §119(e)

The present application claims priority to and incorporates by reference U.S. Provisional Application No. 61/832,317, filed Jun. 7, 2013, entitled “Multiplayer Network Gameplay Notifications.”

### TECHNICAL FIELD

The subject matter disclosed herein generally relates to the playing of games. Specifically, in one example, the present disclosure addresses systems and methods to notify players of events in a game.

### BACKGROUND

In military-style strategy games, players may build or recruit units and use these units to attack territory or units controlled by other players, or to defend the territory of the owning player.

A user may interact with a game through a user interface (“UI”).

Push notifications, such as those served by the Apple Push Notification Service, allow an application to send notifications to users and receive a response, even when the user is not running the application sending the notification.

### BRIEF DESCRIPTION OF THE DRAWINGS

Some embodiments are illustrated by way of example and not limitation in the figures of the accompanying drawings.

FIG. 1 is a block diagram illustrating an example of a system for implementing particular disclosed embodiments.

FIG. 2 is a block diagram illustrating an example social network.

FIG. 3A is a pair of block diagrams illustrating components of a server machine or a client machine suitable for implementing particular disclosed embodiments.

FIG. 3B is a block diagram illustrating components of a game engine suitable for implementing particular disclosed embodiments.

FIG. 4 is a block diagram illustrating an example user interface of an example game instance.

FIG. 5 is a block diagram illustrating an example user interface of an example game instance.

FIG. 6 is a block diagram illustrating an example user interface of an example game instance.

FIG. 7 is a block diagram illustrating an example user interface of an example game instance.

FIG. 8 is a block diagram illustrating an example user interface of an example game instance.

FIG. 9 is a block diagram illustrating an example user interface of an example game instance.

FIG. 10 is a block diagram illustrating an example user interface of an example game instance.

FIG. 11 is a block diagram illustrating an example user interface of an example game instance.

FIG. 12 is a flowchart illustrating operations of a device in performing particular disclosed embodiments.

FIG. 13 is a flowchart illustrating operations of a device in performing particular disclosed embodiments.

FIG. 14 is a flow chart illustrating an example data flow in a system.

FIG. 15 is a block diagram illustrating data structures in example embodiments.

FIG. 16 is a network diagram illustrating an example network environment.

FIG. 17 is a block diagram illustrating an example computer system architecture.

### DETAILED DESCRIPTION

Example methods and systems are directed to notifying a third player of an attack by a first player against a second player and allowing the third player to intervene. Examples merely typify possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

Multiple players in a game can form a guild. The guild can work toward projects, lend troops for battles, and protect their village. Guilds may compete with each other, attack each other, be ranked against each other, or any suitable combination thereof. The guild may have a chat channel. The chat channel may restrict participation to guild members. Members of a guild may be shown a neighbor bar that includes information about neighbors, such as neighbor names, profile pictures, status information, character level, or any suitable combination thereof. In some example embodiments, members of a guild to which the player belongs are neighbors. Optionally, members of the player's social network are neighbors.

When two members of a guild are connected to the game and one attacks another player, the other guild member may be informed. In some example embodiments, the informed guild member may click on the profile picture or name of the attacking player and add units to the battle. In response, the attacking player may receive an audio alert, a visual alert, or both. The attacking player may see the aiding troops appear. The profile picture or name of the aiding player may also be shown to the attacking player. In some example embodiments, assistance is received in this manner from multiple guildmates. In some example embodiments, the player being attacked may also receive aid in this manner from one or more guildmates. The number of aiding players may be capped, e.g., at two on each side. In some example embodiments, the battle is only seen by the active player making the attack. In some example embodiments, the aiding player does not choose the type of troops to donate; instead, they are determined by a level of the guild. For example, donated troops may be based on an overall level of the guild, a level of an ability related to the troop-donating feature, or both. In some example embodiments, there is no cost for the donation of troops. In other example embodiments, there is a cost either to the player or the guild.

The aiding troops may be added to the battle substantially in real-time, in response to the aiding player's decision to help. In some example embodiments, the aiding player has a limited time (e.g., 10 seconds, 30 seconds, 5 minutes, or the duration of the battle) to decide to help. A notification of the aid may be presented to the player being attacked. The notification may be presented by email, a social network, a chat channel, the UI of a running application, a push notification, or any suitable combination thereof.

Additionally or alternatively, a notification of an attack may be presented to a player being attacked. The player may have a limited period of time to respond to the notification (e.g., 10 seconds, 30 seconds, 5 minutes, or the duration of the battle). Damage received by the player may be reduced based on the player responding to the notification. For example, if an enemy attack destroyed 100 resources, responding to the notification may return 50 resources. In some example embodiments, the amount returned is based on the time taken to respond. For example, if a player could recover up to 50 resources, the player may have 50 seconds to respond, with the amount of resources recovered proportional to the speed of the response. The notification may be presented by email, a social network, a chat channel, the UI of a running application, a push notification, or any suitable combination thereof.

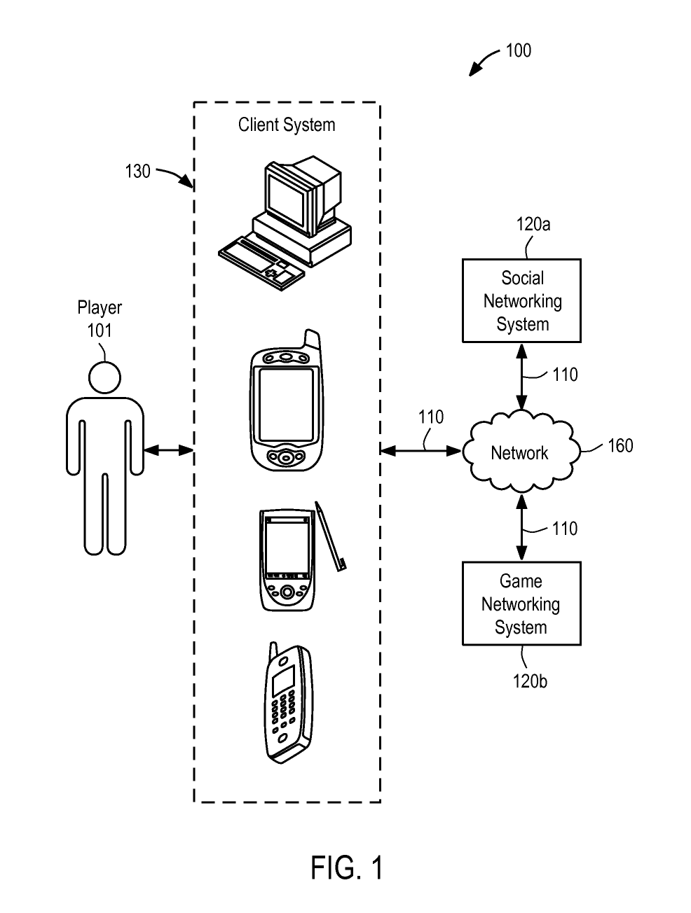

FIG. 1 is a block diagram illustrating an example of a system for implementing particular disclosed embodiments. In particular embodiments, system 100 comprises player 101, social networking system 120a, game networking system 120b, client system 130, and network 160. The components of system 100 can be connected to each other in any suitable configuration, using any suitable type of connection 110. The components may be connected directly or over a network 160, which may be any suitable network. For example, one or more portions of network 160 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, another type of network, or a combination of two or more such networks.

Social networking system 120a is a network-addressable computing system that can host one or more social graphs. Social networking system 120a can generate, store, receive, and transmit social networking data. Social networking system 120a can be accessed by the other components of system 100 either directly or via network 160. Game networking system 120b is a network-addressable computing system that can host one or more online games. Game networking system 120b can generate, store, receive, and transmit game-related data, such as, for example, game account data, game input, game state data, and game displays. Game networking system 120b can be accessed by the other components of system 100 either directly or via network 160. Player 101 may use client system 130 to access, send data to, and receive data from social networking system 120a and game networking system 120b. Client system 130 can access social networking system 120a or game networking system 120b directly, via network 160, or via a third-party system. As an example and not by way of limitation, client system 130 may access game networking system 120b via social networking system 120a. Client system 130 can be any suitable computing device, such as a personal computer, laptop, cellular phone, smart phone, computing tablet, etc.

Although FIG. 1 illustrates one player 101, social networking system 120a, game networking system 120b, client system 130, and network 160, this disclosure contemplates any suitable number of players 101, social networking systems 120a, game networking systems 120b, client systems 130, and networks 160. As an example and not by way of limitation, system 100 may include one or more game networking systems 120b and no social networking systems 120a. As another example and not by way of limitation, system 100 may include a system that comprises both social networking system 120a and game networking system 120b. Moreover, although FIG. 1 illustrates a particular arrangement of player 101, social networking system 120a, game networking system 120b, client system 130, and network 160, this disclosure contemplates any suitable arrangement of player 101, social networking system 120a, game networking system 120b, client system 130, and network 160.

The components of system 100 may be connected to each other using any suitable connections 110. For example, suitable connections 110 include wireline (such as, for example, Digital Subscriber Line (DSL) or Data Over Cable Service Interface Specification (DOCSIS)), wireless (such as, for example, Wi-Fi or Worldwide Interoperability for Microwave Access (WiMAX)) or optical (such as, for example, Synchronous Optical Network (SONET) or Synchronous Digital Hierarchy (SDH)) connections. In particular embodiments, one or more connections 110 each include an ad hoc network, an intranet, an extranet, a VPN, a LAN, a WLAN, a WAN, a WWAN, a MAN, a portion of the Internet, a portion of the PSTN, a cellular telephone network, or another type of connection, or a combination of two or more such connections. Connections 110 need not necessarily be the same throughout system 100. One or more first connections 110 may differ in one or more respects from one or more second connections 110. Although FIG. 1 illustrates particular connections 110 between player 101, social networking system 120a, game networking system 120b, client system 130, and network 160, this disclosure contemplates any suitable connections between player 101, social networking system 120a, game networking system 120b, client system 130, and network 160. As an example and not by way of limitation, in particular embodiments, client system 130 may have a direct connection to social networking system 120a or game networking system 120b, bypassing network 160.

### Online Games and Game Systems—Game Networking Systems

In an online computer game, a game engine manages the game state of the game. Game state comprises all game play parameters, including player character state, non-player character (NPC) state, in-game object state, game world state (e.g., internal game clocks, game environment), and other game play parameters. Each player 101 controls one or more player characters (PCs). The game engine controls all other aspects of the game, including non-player characters (NPCs), and in-game objects. The game engine also manages game state, including player character state for currently active (online) and inactive (offline) players.

An online game can be hosted by game networking system 120b, which can be accessed using any suitable connection 110 with a suitable client system 130. A player 101 may have a game account on game networking system 120b, wherein the game account can contain a variety of information associated with the player 101 (e.g., the player's personal information, financial information, purchase history, player character state, game state). In some embodiments, a player 101 may play multiple games on game networking system 120b, which may maintain a single game account for the player 101 with respect to all the games, or multiple individual game accounts for each game with respect to the player 101. In some embodiments, game networking system 120b can assign a unique identifier to each player 101 of an online game hosted on game networking system 120b. Game networking system 120b can determine that a player 101 is accessing the online game by reading the user's cookies, which may be appended to HTTP requests transmitted by client system 130, and/or by the player 101 logging onto the online game. “User” may refer to the user of a computer system used to play the game while “player” may refer to an individual that created a game account used to play the game or to a player character controlled by a player or a user. In many circumstances, “player” and “user” may be used interchangeably.

In particular embodiments, player 101 may access an online game and control the game's progress via client system 130 (e.g., by inputting commands to the game at the client device). Client system 130 can display the game interface, receive inputs from player 101, transmit user inputs or other events to the game engine, and receive instructions from the game engine. The game engine can be executed on any suitable system (such as, for example, client system 130, social networking system 120a, or game networking system 120b). As an example and not by way of limitation, client system 130 can download client components of an online game, which are executed locally, while a remote game server, such as game networking system 120b, provides backend support for the client components and may be responsible for maintaining application data of the game, processing the inputs from the player 101, updating and/or synchronizing the game state based on the game logic and each input from the player 101, and transmitting instructions to client system 130. As another example and not by way of limitation, each time player 101 provides an input to the game through the client system 130 (such as, for example, by typing on the keyboard or clicking the mouse of client system 130), the client components of the game may transmit the player 101's input to game networking system 120b.

### Online Games and Game Systems—Game Play

In particular embodiments, player 101 can engage in or cause a player character controlled by him to engage in one or more in-game actions. For a particular game, various types of in-game actions may be available to player 101. As an example and not by way of limitation, a player character in an online role-playing game may be able to interact with other player characters, build a virtual house, attack enemies, go on a quest, and go to a virtual store to buy/sell virtual items. As another example and not by way of limitation, a player character in an online poker game may be able to play at specific tables, place bets of virtual or legal currency for certain amounts, discard or hold certain cards, play or fold certain hands, and play in a online poker tournament. In another example, a player character in an online strategy war game may be able to attack the territory of another player, defend the territory of the player, assist in the defense of another player's territory, or any suitable combination thereof.

In particular embodiments, player 101 may engage in an in-game action by providing one or more user inputs to client system 130. Various actions may call for various types and numbers of user inputs. Some types of in-game actions may call for a single user input. As an example and not by way of limitation, player 101 may be able to harvest a virtual crop by clicking on it once with a mouse. Some types of in-game actions may call for multiple user inputs. As another example and not by way of limitation, player 101 may be able to throw a virtual fireball at an in-game object by entering the following sequence on a keyboard: DOWN, DOWN and RIGHT, RIGHT, B. This disclosure contemplates engaging in in-game actions using any suitable number and type of user inputs.

In particular embodiments, player 101 can perform an in-game action on an in-game object. An in-game object is any interactive element of an online game. In-game objects may include, for example, PCs, NPCs, in-game assets and other virtual items, in-game obstacles, game elements, game features, and other in-game objects. This disclosure contemplates performing in-game actions on any suitable in-game objects. For a particular in-game object, various types of in-game actions may be available to player 101 based on the type of in-game object. As an example and not by way of limitation, if player 101 encounters a virtual bear, the game engine may give him the options of shooting the bear or petting the bear. Some in-game actions may be available for particular types of in-game objects but not other types. As an example and not by way of limitation, if player 101 encounters a virtual rock, the game engine may give him the option of moving the rock; however, unlike the virtual bear, the game engine may not allow player 101 to shoot or pet the virtual rock. Furthermore, for a particular in-game object, various types of in-game actions may be available to player 101 based on the game state of the in-game object. As an example and not by way of limitation, if player 101 encounters a virtual crop that was recently planted, the game engine may give him only the option of fertilizing the crop, but if player 101 returns to the virtual crop later when it is fully grown, the game engine may give him only the option of harvesting the crop.

In particular embodiments, the game engine may cause one or more game events to occur in the game. Game events may include, for example, a change in game state, an outcome of an engagement, a completion of an in-game obstacle, a transfer of an in-game asset or other virtual item, or a provision of access, rights and/or benefits. In particular embodiments, a game event is any change in game state. Similarly, any change in game state may be a game event. This disclosure contemplates any suitable type of game event. As an example and not by way of limitation, the game engine may cause a game event where the virtual world cycles between daytime and nighttime every 24 hours. As another example and not by way of limitation, the game engine may cause a game event where a new instance, level, or area of the game becomes available to player 101. As yet another example and not by way of limitation, the game engine may cause a game event where player 101's player character heals one hit point every 5 minutes.

In particular embodiments, a game event or change in game state may be an outcome of one or more in-game actions. The game engine can determine the outcome of a game event or a change in game state according to a variety of factors, such as, for example, game logic or rules, player character in-game actions, player character state, game state of one or more in-game objects, interactions of other player characters, or random calculations. As an example and not by way of limitation, player 101 may overcome an in-game obstacle and earn sufficient experience points to advance to the next level, thereby changing the game state of player 101's player character (e.g., advancing it to the next character level). As another example and not by way of limitation, player 101 may defeat a particular boss NPC in a game instance, thereby causing a game event where the game instance is completed and the player 101 advances to a new game instance. As yet another example and not by way of limitation, player 101 may pick the lock on a virtual door to open it, thereby changing the game state of the door (it goes from closed to open) and causing a game event (the player 101 can access a new area of the game).

In particular embodiments, player 101 may access particular game instances of an online game. A game instance is copy of a specific game play area that is created during runtime. In particular embodiments, a game instance is a discrete game play area where one or more players 101 can interact in synchronous or asynchronous play. A game instance may be, for example, a level, zone, area, region, location, virtual space, or other suitable play area. A game instance may be populated by one or more in-game objects. Each object may be defined within the game instance by one or more variables, such as, for example, position, height, width, depth, direction, time, duration, speed, color, and other suitable variables. A game instance may be exclusive (i.e., accessible by specific players) or non-exclusive (i.e., accessible by any player). In particular embodiments, a game instance is populated by one or more player characters controlled by one or more players 101 and one or more in-game objects controlled by the game engine. When accessing an online game, the game engine may allow player 101 to select a particular game instance to play from a plurality of game instances. Alternatively, the game engine may automatically select the game instance that player 101 will access. In particular embodiments, an online game comprises only one game instance that all players 101 of the online game can access.

In particular embodiments, a specific game instance may be associated with one or more specific players. A game instance is associated with a specific player when one or more game parameters of the game instance are associated with the specific player. As an example and not by way of limitation, a game instance associated with a first player may be named “First Player's Play Area.” This game instance may be populated with the first player's PC and one or more in-game objects associated with the first player. In particular embodiments, a game instance associated with a specific player may only be accessible by that specific player. As an example and not by way of limitation, a first player may access a first game instance when playing an online game, and this first game instance may be inaccessible to all other players. In other embodiments, a game instance associated with a specific player may be accessible by one or more other players, either synchronously or asynchronously with the specific player's game play. As an example and not by way of limitation, a first player may be associated with a first game instance, but the first game instance may be accessed by all first-degree friends in the first player's social network. In particular embodiments, the game engine may create a specific game instance for a specific player when that player accesses the game. As an example and not by way of limitation, the game engine may create a first game instance when a first player initially accesses an online game, and that same game instance may be loaded each time the first player accesses the game. As another example and not by way of limitation, the game engine may create a new game instance each time a first player accesses an online game, wherein each game instance may be created randomly or selected from a set of predetermined game instances. In particular embodiments, the set of in-game actions available to a specific player may be different in a game instance that is associated with that player compared to a game instance that is not associated with that player. The set of in-game actions available to a specific player in a game instance associated with that player may be a subset, superset, or independent of the set of in-game actions available to that player in a game instance that is not associated with him. As an example and not by way of limitation, a first player may be associated with Blackacre Farm in an online farming game. The first player may be able to plant crops on Blackacre Farm. If the first player accesses game instance associated with another player, such as Whiteacre Farm, the game engine may not allow the first player to plant crops in that game instance. However, other in-game actions may be available to the first player, such as watering or fertilizing crops on Whiteacre Farm.

### Social Graphs and Social Networking Systems

In particular embodiments, a game engine can interface with a social graph. Social graphs are models of connections between entities (e.g., individuals, users, contacts, friends, players, player characters, non-player characters, businesses, groups, associations, concepts, etc.). These entities are considered “users” of the social graph; as such, the terms “entity” and “user” may be used interchangeably when referring to social graphs herein. A social graph can have a node for each entity and edges to represent relationships between entities. A node in a social graph can represent any entity. In particular embodiments, a unique client identifier can be assigned to each user in the social graph. This disclosure assumes that at least one entity of a social graph is a player or player character in an online multiplayer game, though this disclosure contemplates any suitable social graph users.

The minimum number of edges needed to connect a player (or player character) to another user is considered the degree of separation between them. For example, where the player and the user are directly connected (one edge), they are deemed to be separated by one degree of separation. The user would be a so-called “first-degree friend” of the player. Where the player and the user are connected through one other user (two edges), they are deemed to be separated by two degrees of separation. This user would be a so-called “second-degree friend” of the player. Where the player and the user are connected through N edges (or N−1 other users), they are deemed to be separated by N degrees of separation. This user would be a so-called “Nth-degree friend.” As used herein, the term “friend” means only first-degree friends, unless context suggests otherwise.

Within the social graph, each player (or player character) has a social network. A player's social network includes all users in the social graph within Nₘₐₓ degrees of the player, where Nₘₐₓ is the maximum degree of separation allowed by the system managing the social graph (such as, for example, social networking system 120a or game networking system 120b). In one embodiment, Nₘₐₓ equals 1, such that the player's social network includes only first-degree friends. In another embodiment, Nₘₐₓ is unlimited and the player's social network is coextensive with the social graph.

In particular embodiments, the social graph is managed by game networking system 120b, which is managed by the game operator. In other embodiments, the social graph is part of a social networking system 120a managed by a third-party (e.g., Facebook, Friendster, Myspace). In yet other embodiments, player 101 has a social network on both game networking system 120b and social networking system 120a, wherein player 101 can have a social network on the game networking system 120b that is a subset, superset, or independent of the player 101's social network on social networking system 120a. In such combined systems, game networking system 120b can maintain social graph information with edge type attributes that indicate whether a given friend is an “in-game friend,” an “out-of-game friend,” or both. The various embodiments disclosed herein are operable when the social graph is managed by social networking system 120a, game networking system 120b, or both.

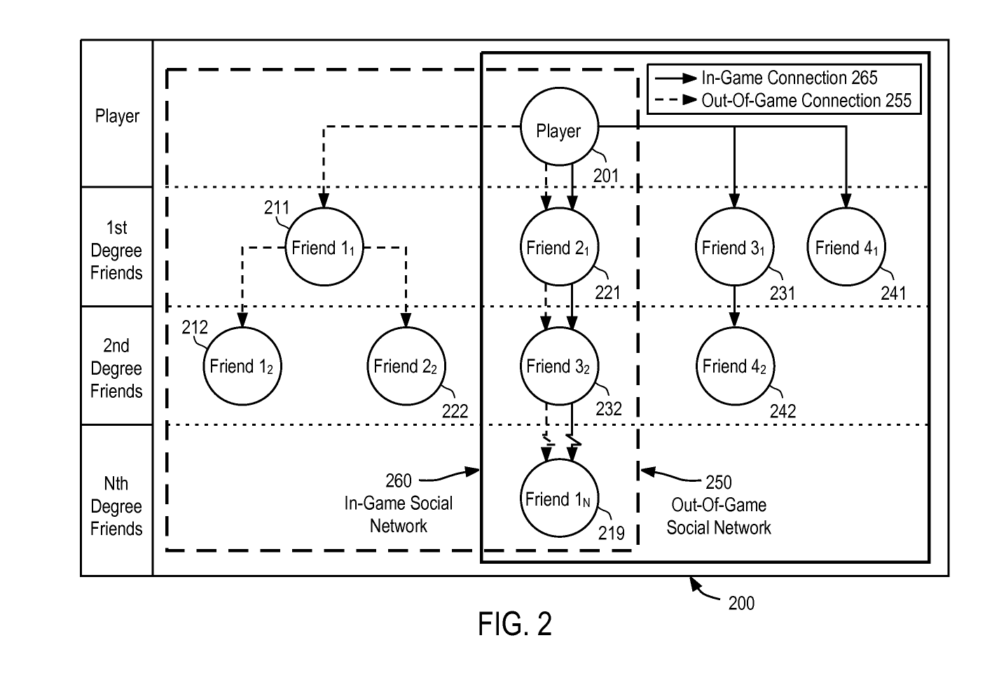

FIG. 2 shows an example of a social network 200 within a social graph. As shown, Player 201 can be associated, connected or linked to various other users, or “friends,” within the social network 200. These associations, connections or links can track relationships between users within the social network 200 and are commonly referred to as online “friends” or “friendships” between users. Each friend or friendship in a particular user's social network within a social graph is commonly referred to as a “node.” For purposes of illustration and not by way of limitation, the details of social network 200 will be described in relation to Player 201. As used herein, the terms “player” and “user” can be used interchangeably and can refer to any user or character in an online multiuser game system or social networking system. As used herein, the term “friend” can mean any node within a player's social network.

As shown in FIG. 2, Player 201 has direct connections with several friends. When Player 201 has a direct connection with another individual, that connection is referred to as a first-degree friend. In social network 200, Player 201 has two first-degree friends. That is, Player 201 is directly connected to Friend 1₁ 211 and Friend 2₁ 221. In a social graph, it is possible for individuals to be connected to other individuals through their first-degree friends (i.e., friends of friends). As described above, the number of edges needed to connect a player to another user is considered the degree of separation. For example, FIG. 2 shows that Player 201 has three second-degree friends to which he is connected via his connection to his first-degree friends. Second-degree Friend 1₂ 212 and Friend 2₂ 222 are connected to Player 201 via his first-degree Friend 1₁ 211. The limit on the depth of friend connections, or the number of degrees of separation for associations, that Player 201 is allowed is typically dictated by the restrictions and policies implemented by social networking system 120a.

In various embodiments, Player 201 can have Nth-degree friends connected to him through a chain of intermediary degree friends as indicated in FIG. 2. For example, Nth-degree Friend 1_{N} 219 is connected to Player 201 via second-degree Friend 3₂ 232 and one or more other higher-degree friends. Various embodiments may benefit from and utilize the distinction between the various degrees of friendship relative to Player 201.

In particular embodiments, a player (or player character) can have a social graph within an online multiplayer game that is maintained by the game engine and another social graph maintained by a separate social networking system. FIG. 2 depicts an example of in-game social network 260 and out-of-game social network 250. In this example, Player 201 has out-of-game connections 255 to a plurality of friends, forming out-of-game social network 250. Here, Friend 1₁ 211 and Friend 2₁ 221 are first-degree friends with Player 201 in his out-of-game social network 250. Player 201 also has in-game connections 265 to a plurality of players, forming in-game social network 260. Here, Friend 2₁ 221, Friend 3₁ 231, and Friend 4₁ 241 are first-degree friends with Player 201 in his in-game social network 260. In some embodiments, it is possible for a friend to be in both the out-of-game social network 250 and the in-game social network 260. Here, Friend 2₁ 221 has both an out-of-game connection 255 and an in-game connection 265 with Player 201, such that Friend 2₁ 221 is in both Player 201's in-game social network 260 and Player 201's out-of-game social network 250.

As with other social networks, Player 201 can have second-degree and higher-degree friends in both his in-game and out of game social networks 260, 250. In some embodiments, it is possible for Player 201 to have a friend connected to him both in his in-game and out-of-game social networks 260, 250, wherein the friend is at different degrees of separation in each network. For example, if Friend 2₂ 222 had a direct in-game connection with Player 201, Friend 2₂ 222 would be a second-degree friend in Player 201's out-of-game social network 250, but a first-degree friend in Player 201's in-game social network 260. In particular embodiments, a game engine can access in-game social network 260, out-of-game social network 250, or both.

In particular embodiments, the connections in a player's in-game social network 260 can be formed both explicitly (e.g., users have to “friend” each other) and implicitly (e.g., system observes user behaviors and “friends” users to each other). Unless otherwise indicated, reference to a friend connection between two or more players can be interpreted to cover both explicit and implicit connections, using one or more social graphs and other factors to infer friend connections. The friend connections can be unidirectional or bidirectional. It is also not a limitation of this description that two players who are deemed “friends” for the purposes of this disclosure are not friends in real life (i.e., in disintermediated interactions or the like), but that could be the case.

### Asynchronous Game Play

In multiplayer online games, two or more players can play in the same game instance. Game play is asynchronous when the players do not play simultaneously in the game instance. In particular embodiments, synchronous game play between two players in the same game instance can be simulated from asynchronous game play by recording the game play of a first player in the game instance at a first time and replaying that game play during the game play of a second player in the game instance at a later time.

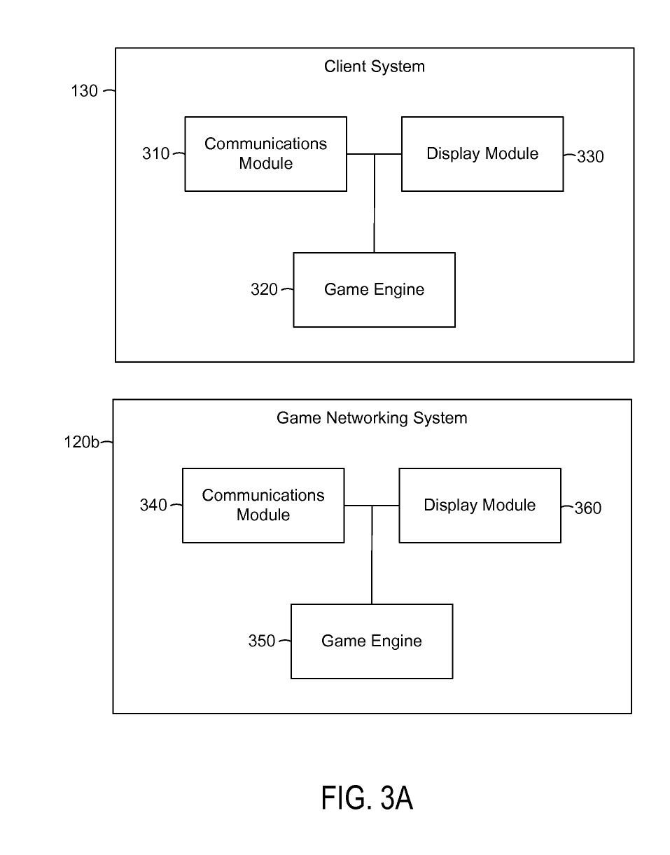

FIG. 3A is a pair of block diagrams illustrating components of the client system 130 and the game networking system 120b, according to some example embodiments. The client system 130 is shown as including a communications module 310, a game engine 320, and a display module 330, all configured to communicate with each other (e.g., via a bus, shared memory, or a switch). The game networking system 120b is also shown as including a communications module 340, a game engine 350, and a display module 360, all configured to communicate with each other (e.g., via a bus, shared memory, or a switch). Any one or more of the modules described herein may be implemented using hardware (e.g., a processor of a machine) or a combination of hardware and software. For example, any module described herein may configure a processor to perform the operations described herein for that module. Moreover, any two or more of these modules may be combined into a single module, and the functions described herein for a single module may be subdivided among multiple modules. Furthermore, according to various example embodiments, modules described herein as being implemented within a single machine, database, or device may be distributed across multiple machines, databases, or devices.

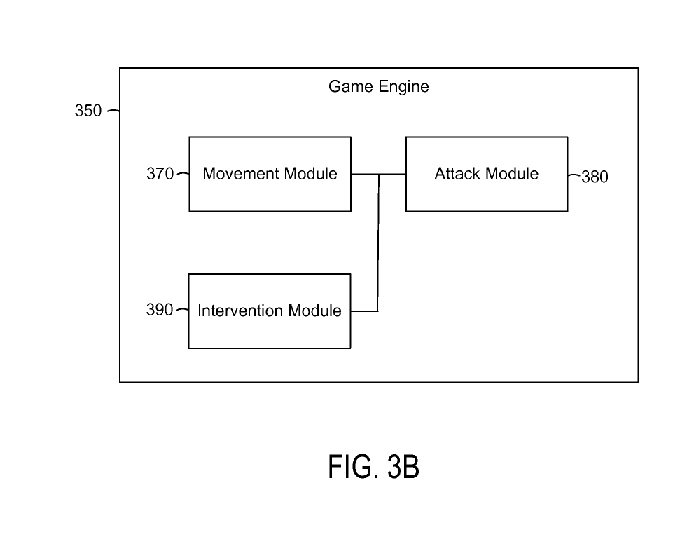

The communications modules 310 and 340 may be configured to send and receive data between the client system 130 and the game networking system 120b. For example, the client system 130 may send data including the game choices made by the user to the game networking system 120b via the communications module 310. As another example, the game networking system 120b may receive the game choices via the communications module 340, process them using the game engine 350, and send a response via the communications module 340. In some example embodiments, the display module 360 of the game networking system 120b causes the display of results from the game action on the client system 130. In some example embodiments, the display module 330 of the client system 130 interprets results received by the communications module 310 and causes the display of results from the game action on the client system 130. In some example embodiments, calculation of the results of the game action is performed in the game engine 320 of the client system 130, the game engine 350 of the game networking system 120b, or both. Further details regarding the functions of the modules 310-360 are discussed below, with respect to FIGS. 4-15.

FIG. 3B is a block diagram illustrating components of a game engine 320 or 350, according to some example embodiments. The game engine 320 or 350 may include a movement module 370, an attack module 380, and an intervention module 390.

The movement module 370 may control the movement of units within the game. For example, a player may send a command to one or more units to attack a building in an enemy territory. The units may move across a play area to reach the building. The units may move in straight lines or along a grid. For example, the position of the units may be defined in (x,y) coordinates, with the size of the coordinate grid such that each unit is much larger than a single coordinate element. In this way, the units may appear to be arbitrarily placed relative to the coordinate grid. In another example, the position of the units may be defined as a position on a grid, with the size of the coordinate grid such that each unit is similar in size to a single coordinate element (e.g., the same size, half of the size, twice the size, or the like). In this way, the units may appear to be placed in a limited set of positions relative to the playing area. The movement module 370 may take into account a number of factors in determining the movement of a unit. For example, a speed of the unit, a movement modifier (e.g., a terrain modifier) of the play area the unit is on, an attribute of the player controlling the unit (e.g., a researched speed bonus), an attribute of the player controlling the play area (e.g., a defensive spell causing a speed penalty to enemy units), a health of the unit (e.g., a speed reduction due to damage taken), and so on.

By way of example, the A* algorithm may be used to determine the path taken by a unit in getting from a starting location to a destination location. During the movement of the unit, the speed of the unit may be determined by the following formula: (Unit Base Speed)×(Terrain Modifier)×(Player Bonus)×(Opponent Penalty). For example, a unit may have a base speed of 50 pixels/second, 2 tiles/day, or 100 miles/hour. On flat terrain, the terrain modifier may be 1.0; on swampy terrain, the terrain modifier may be 0.5; on mountain terrain, the terrain modifier may be 0.75. A player may ordinarily not have a player bonus, and 1.0 may be used for the player bonus element. The player may have a temporary power up providing 25% increased movement speed, and 1.25 may be used for the player bonus element. Likewise, the opponent may not ordinarily have an opponent penalty, and 1.0 may be used for the opponent penalty element. The player may cast a defensive spell providing 25% reduced movement speed, and 0.75 may be used for the player bonus element. Thus, in an example embodiment, a unit with a speed of 50 pixels/second belonging to a player with a speed bonus (1.25) on swampy terrain (0.5) attacking a player having a movement penalty (0.75) would have a resulting speed of 23.4375 pixels/second. In some example embodiments, the speed is rounded to a game- or processor-determined degree of precision. For example, the speed of 23.4375 pixels/second may be rounded to 23 pixels/second. In some example embodiments, more or fewer elements are used to calculate the unit speed. For example, a terrain modifier may not be used.

The attack module 380 may control the ability of units within the game to deal damage to each other. For example, a unit may have an attack capable of dealing damage at a range. After the movement module 370 has moved the unit to within its range of a target unit (e.g., a target building), the attack module 380 may determine the damage dealt by the attacking unit. The damage may be based on an attack value of the attacking unit, a defense value of the defending unit, a random element, cover provided to the defending unit by terrain, a high-ground bonus provided to the attacking unit by terrain, a range factor (e.g., a decrease in damage at long range or an increase in damage at close range), and so on.

By way of example, the damage dealt may be determined by the following formula: (Attack Value)×(Range Modifier)×(Terrain Modifiers)×(Random Factor)/(Defense Value). For example, a unit may have an attack value of 100. The range modifier may depend on the unit. For example, dispersed gas may do much less damage at its maximum range than close-up, while a rifle bullet deals very similar damage at close range and maximum range. For this example, consider a range modifier that varies linearly with distance, from 1.0 at point-blank range to 0.0 at a maximum range of 200 pixels. Example terrain modifiers are a 1.5 multiplier for the attacker being on higher ground than the defender, and an 0.75 multiplier for the defender being in forest territory that provides some cover. In this example, consider a defending unit with a defense value of 80. Thus, based on the fixed elements, the damage dealt will be 100×0.5×1.5×0.75×(Random Factor)/8, where the range is 100 pixels, resulting in an 0.5 range modifier. As a result, the damage dealt will be 7.03125 multiplied by the Random Factor. The Random Factor may be a random value in any predefined range. For example, between 0 and 1 or between 50 and 100. The Random Factor may be linearly distributed, follow a Gaussian distribution, or use some other distribution.

The intervention module 390 may affect combat in the game. For example, a first player may attack a second player. A third player may intervene in the combat to help one player or the other. The intervention module 390 may create units for the intervention and place them in the area of combat. Additionally or alternatively, the intervention module 390 may take units of the third player and move them into the area of combat. As another option, the intervention module 390 can affect the game state accessed by the attack module 380. For example, the intervening player and the player being aided may belong to a guild with affinity for water. Accordingly, rainy weather may benefit members of the guild more than most other players. In this example, intervention by the water-allied player can alter the game state by causing it to rain during the attack.

FIG. 4 is a block diagram illustrating an example user interface of an example game instance. Shown in FIG. 4 is a user interface (“UI”) 400 with a title 410, a notification 420, and buttons 430 and 440. Also shown is the player's village 450, with buildings 470.

The title 410 may indicate to the player the type of screen being displayed. For example, the title “Village Planning” may indicate that the screen may be used to organize or improve the player's village 450.

The notification 420 may appear to notify the player that an ally is being attacked. The notification 420 may appear for a limited period of time, and vanish automatically if the player does not respond to it.

The button 430, labeled “Help,” may be operable by the player to aid the ally being attacked. In some example embodiments, aid given by the player does not cost the player any game resources, real-world currency, or both. In some example embodiments, choosing to give aid incurs a fixed cost to the player. In some example embodiments, additional UI options may be presented to the player, operable to select the amount of aid given, the type of aid given, or both. Choosing to aid the ally may provide additional units to support the ally in combat. In some example embodiments, the notification 420 is presented to multiple players. The notification 420 may be presented to one or more players chosen by their relationship to the ally in a social network (e.g., first-degree friends, second-degree friends, etc.), chosen by their status as neighbors, chosen by their status as guildmates, or any suitable combination thereof. In some example embodiments, a fixed amount (e.g., number of units, type of units, amount of currency, type of currency, or any suitable combination thereof) of aid is given if any player gives aid. In other example embodiments, the amount of aid given depends on the number of players giving aid, the amount of aid selected by each player, the type of aid selected, or any suitable combination thereof. In some example embodiments, a maximum amount of aid may be gained by the ally this way. Aid may be given in a variety of forms, including resources (e.g., currency), units, offensive or defensive bonuses, or any suitable combination thereof.

The button 440, labeled “Ignore,” may be operable by the player to dismiss the notification 420 without giving aid to the ally being attacked. In some example embodiments, the choice by the player may be made visible to the ally. Alternatively, a choice to aid may be made visible to ally while a choice to ignore the opportunity to help is not shown. In some example embodiments, ignoring the notification 420 and operating the button 440 generate identical results.

The player's village 450 may display all or a portion of a player's territory. The player's territory may be a village, a kingdom, an area, a planet, or other area. The player's territory may include one or more buildings 470. The buildings 470 may be destroyed by attacking units during an attack.

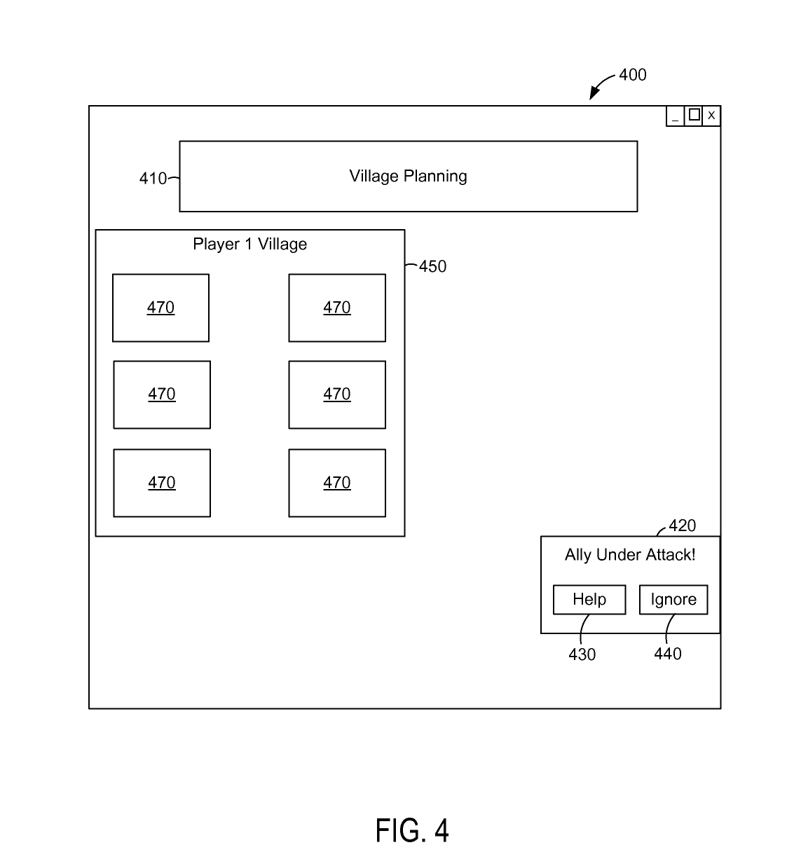

FIG. 5 is a block diagram illustrating an example user interface of an example game instance. Shown in FIG. 5 is a user interface (“UI”) 500 with a title 410, a notification 520, and buttons 530 and 540. Also shown is the player's village 450, with buildings 470.

Elements 410, 450, and 470 are as described above with respect to FIG. 4.

The notification 520 may appear to notify the player that an ally is performing an attack. The notification 520 may appear for a limited period of time, and vanish automatically if the player does not respond to it.

The button 530, labeled “Help,” may be operable by the player to aid the ally in the attack. In some example embodiments, aid given by the player does not cost the player any game resources, real-world currency, or both. In some example embodiments, choosing to give aid incurs a fixed cost to the player. In some example embodiments, additional UI options may be presented to the player, operable to select the amount of aid given, the type of aid given, or both. In some example embodiments, choosing to aid the ally provides additional units to support the ally in combat. In some example embodiments, the notification 520 is presented to multiple players. The notification 520 may be presented to one or more players chosen by their relationship to the ally in a social network (e.g., first-degree friends, second-degree friends, etc.), chosen by their status as neighbors, chosen by their status as guildmates, or any suitable combination thereof. In some example embodiments, a fixed amount (e.g., number of units, type of units, amount of currency, type of currency, or any suitable combination thereof) of aid is given if any player gives aid. In other example embodiments, the amount of aid given depends on the number of players giving aid, the amount of aid selected by each player, the type of aid selected, or any suitable combination thereof. In some example embodiments, a maximum amount of aid may be gained by the ally this way.

The button 540, labeled “Ignore,” may be operable by the player to dismiss the notification 520 without giving aid to the ally performing the attack. In some example embodiments, the choice by the player may be made visible to the ally. In some example embodiments, ignoring the notification 520 and operating the button 540 generate identical results.

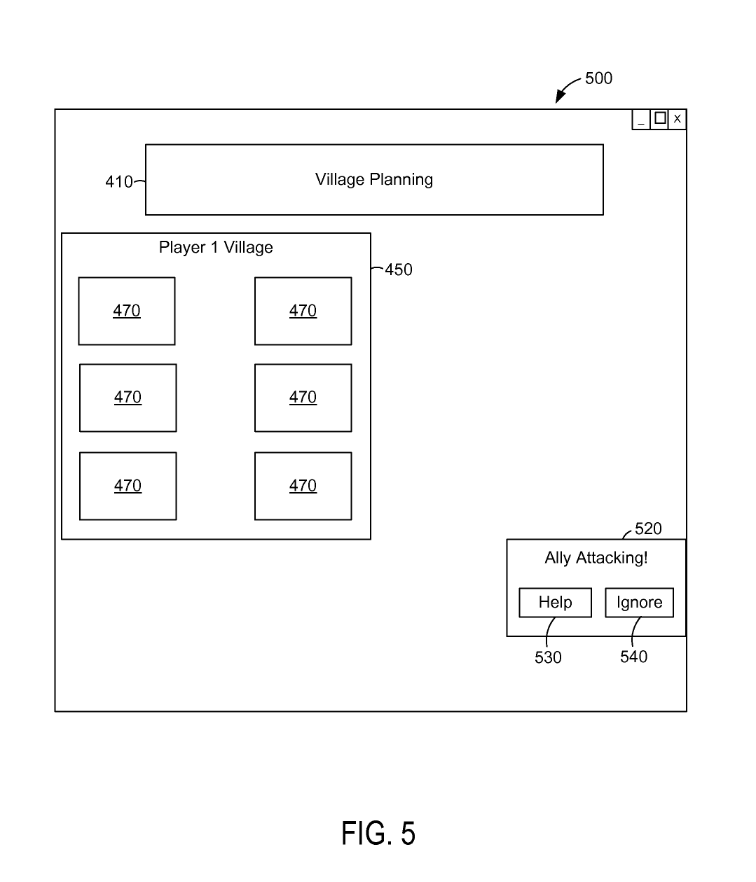

FIG. 6 is a block diagram illustrating an example user interface of an example game instance. Shown in FIG. 6 is a UI 600 with a title 610, buttons 620 and 630, a unit selection title 640, unit type labels 641-643, and unit amounts 644-646. Also shown is the player's village 650, with buildings 470.

The title 610 may indicate to the player the type of screen being displayed. For example, the title “Attack Planning” may indicate that the screen may be used to prepare and launch an attack against another player.

The button 620, labeled “OK,” may be operable by the player to confirm the attack planned via UI 600. In some example embodiments, the attack is automatically begun as units are selected, without an additional step by the player.

The button 630, labeled “Cancel,” may be operable by the player to cancel the attack planned via UI 600. This may undo the selections and return the selected units. In some example embodiments, the attack cannot be canceled.

The unit selection title 640 may indicate an area of the UI 600 containing data regarding units selected to make the attack.

The unit type labels 641-643 may show the different units with which an attack may be launched. For example, infantry, cavalry, and artillery units may be available. In various embodiments, more or fewer unit types may be available to the player.

The unit amounts 644-646 may show the quantity of each unit type available or selected for the attack. In the example shown, 10 infantry, 5 cavalry, and 2 artillery units have been selected.

The target player's village 650 may display all or a portion of a player's territory. In some example embodiments, village 650 corresponds to the village 450. The buildings 470 may be destroyed by attacking units during an attack.

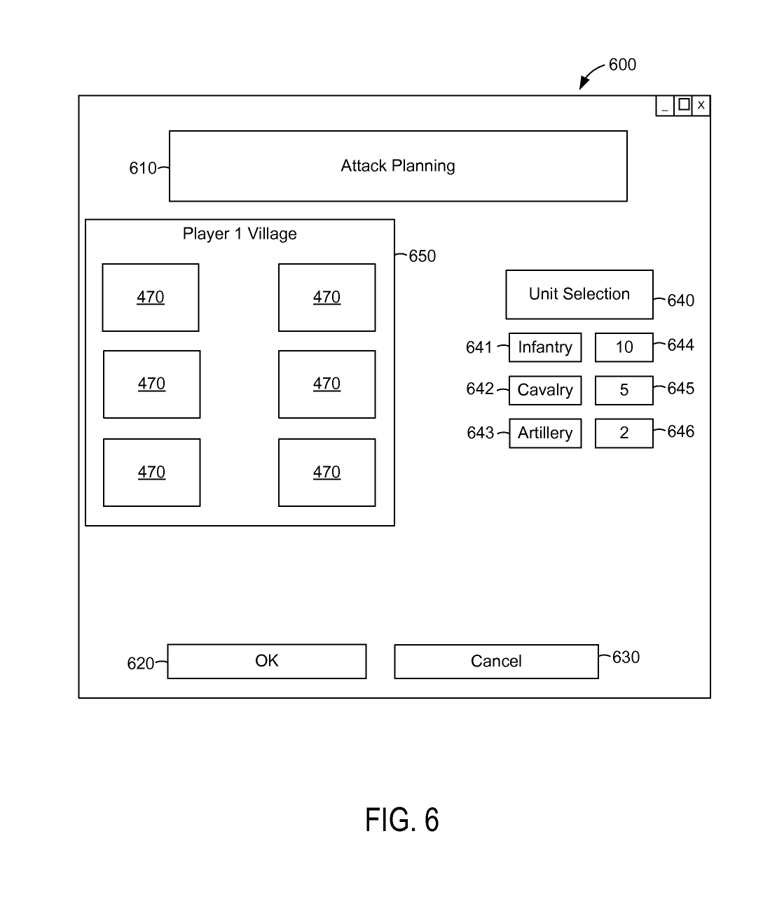

FIG. 7 is a block diagram illustrating an example user interface of an example game instance. The user interface 700 may be displayed on the client system 130 (e.g., a mobile device) with icons 710 and a push notification message area 720 with buttons 730 and 740.

The icons 710 may be operable to launch applications, open documents, or the like, depending on the operating system of the client system 130.

The push notification message area 720 may be displayed on the user interface 700 after the client system 130 receives corresponding data over the network 160. The push notification message area 720 may include a message, such as “Ally Under Attack!” and one or more buttons (e.g., the button 730 and the button 740). In some example embodiments, the push notification may interrupt any other activity engaged in by the player. In some example embodiments, the push notification may be queued by the device for later presentation to the player (e.g., based on a priority setting of the push notification, based on a priority setting of other applications running on the device, based on a push notification setting of the device, or any suitable combination thereof).

In some example embodiments, push notifications received by the client system 130 are handled by an operating system running on the client system 130. Alternatively, push notifications received by the client system 130 may be handled by an application running on the client system 130. For example, a lightweight application that consumes few resources may be running on the client system 130, only to be activated when a push notification is received. In response to receiving the push notification, the lightweight application may present a push notification message area to the player. The push notification message area may be implemented as a lightweight UI (e.g., with only a title and a few buttons) in contrast to a heavyweight UI, which consumes more screen real estate and offers more user options.

The button 730, labeled “Help,” may be operable by the player to aid the ally being attacked. In some example embodiments, aid given by the player does not cost the player any game resources, real-world currency, or both. In some example embodiments, choosing to give aid incurs a fixed cost to the player. In some example embodiments, additional UI options may be presented to the player, operable to select the amount of aid given, the type of aid given, or both. In some example embodiments, choosing to aid the ally provides additional units to support the ally in combat. The push notification message area 720 may be presented to multiple players. The players receiving the push notification message area 720 may be chosen by their relationship to the ally in a social network (e.g., first-degree friends, second-degree friends, etc.), chosen by their status as neighbors, chosen by their status as guildmates, or any suitable combination thereof. In some example embodiments, a fixed amount (e.g., number of units, type of units, amount of currency, type of currency, or any suitable combination thereof) of aid is given if any player gives aid. In other example embodiments, the amount of aid given depends on the number of players giving aid, the amount of aid selected by each player, the type of aid selected by each player, or any suitable combination thereof. In some example embodiments, a maximum amount of aid may be gained by the ally this way.

The button 740, labeled “Ignore,” may be operable by the player to dismiss the notification without giving aid to the ally being attacked. In some example embodiments, the choice by the player may be made visible to the ally. In some example embodiments, ignoring the notification and operating the button 740 generate identical results.

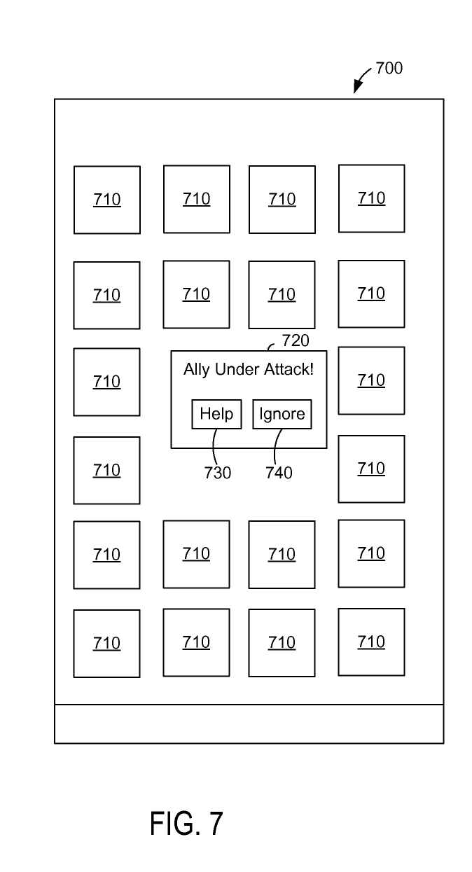

FIG. 8 is a block diagram illustrating another embodiment of the example user interface of FIG. 7. Shown in FIG. 8 is the user interface 800 with icons 710 and a push notification message area 820 with buttons 830 and 840. The icons 710 are described above with respect to FIG. 7.

The push notification message area 820 may be displayed on the screen of the client system 130 after the client system 130 receives corresponding data over the network 160. The push notification may include a message, such as “Ally Attacking!” and one or more buttons 830 and 840. In some example embodiments, the push notification may interrupt another activity engaged in by the player. In some example embodiments, the push notification may be queued by the device for later presentation to the player.

The button 830, labeled “Help,” may be operable by the player to aid the ally in the attack. In some example embodiments, aid given by the player does not cost the player any game resources, real-world currency, or both. In some example embodiments, choosing to give aid incurs a fixed cost to the player. In some example embodiments, additional UI options may be presented to the player, operable to select the amount of aid given, the type of aid given, or both. In some example embodiments, choosing to aid the ally provides additional units to support the ally in combat. In some example embodiments, the push notification message area 820 is presented to multiple players. The push notification message area 820 may be presented to one or more players chosen by their relationship to the ally in a social network (e.g., first-degree friends, second-degree friends, etc.), chosen by their status as neighbors, chosen by their status as guildmates, or any suitable combination thereof. In some example embodiments, a fixed amount (e.g., number of units, type of units, amount of currency, type of currency, or any suitable combination thereof) of aid is given if any player gives aid. In other example embodiments, the amount of aid given depends on the number of players giving aid, the amount of aid selected by each player, the type of aid selected, or any suitable combination thereof. In some example embodiments, a maximum amount of aid may be gained by the ally this way.

The button 840, labeled “Ignore,” may be operable by the player to dismiss the notification without giving aid to the ally performing the attack. In some example embodiments, the choice by the player may be made visible to the ally. In some example embodiments, ignoring the notification and operating the button 840 generate identical results.

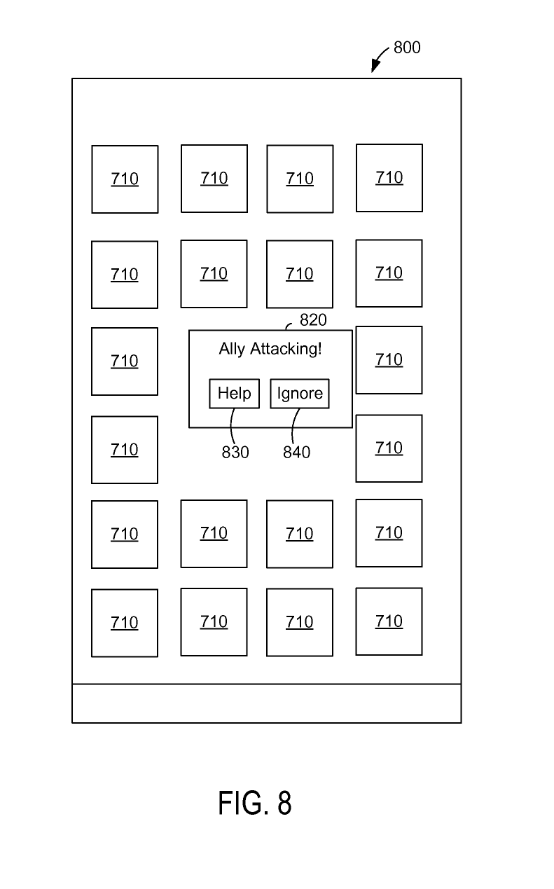

FIG. 9 is a block diagram illustrating an example user interface of an example game instance. Shown in FIG. 9 is a UI 900 with a title 410, a player's village 450, buildings 470, a neighbor bar 920, friend status areas 930-950, and buttons 960-970. The elements 410, 450, and 470 are as described above with respect to FIG. 4.

The neighbor bar 920 shows the status of a selection of other players in the game. The selected players may be part of the player's guild, located geographically near the player in the real world, located near the player in a virtual world, at a similar point of progression as the player, or selected using other criteria. In the example embodiment shown, information about three friends is shown. The friends may be guildmates, friends in a social network, or otherwise associated with the player.

The status areas 930-950 each show the name and status of a player. For example, the status area 930 shows that Friend A is currently building. The status area 940 shows that Friend B is currently attacking. The status area 950 shows that Friend C is currently defending.

The buttons 960 and 970 are operable to allow the player to intervene in the actions of Friend B and Friend C. In the example shown, the buttons 960 and 970 are labeled “Help,” and may cause the player to assist in the friends' attack or defense. In another example, the neighbors shown may be opponents of the player and the button may be operable to hinder the opponents' efforts. In still another example, the neighbors may not be pre-assigned as allies or opponents and the player may be presented both helping and hindering options.

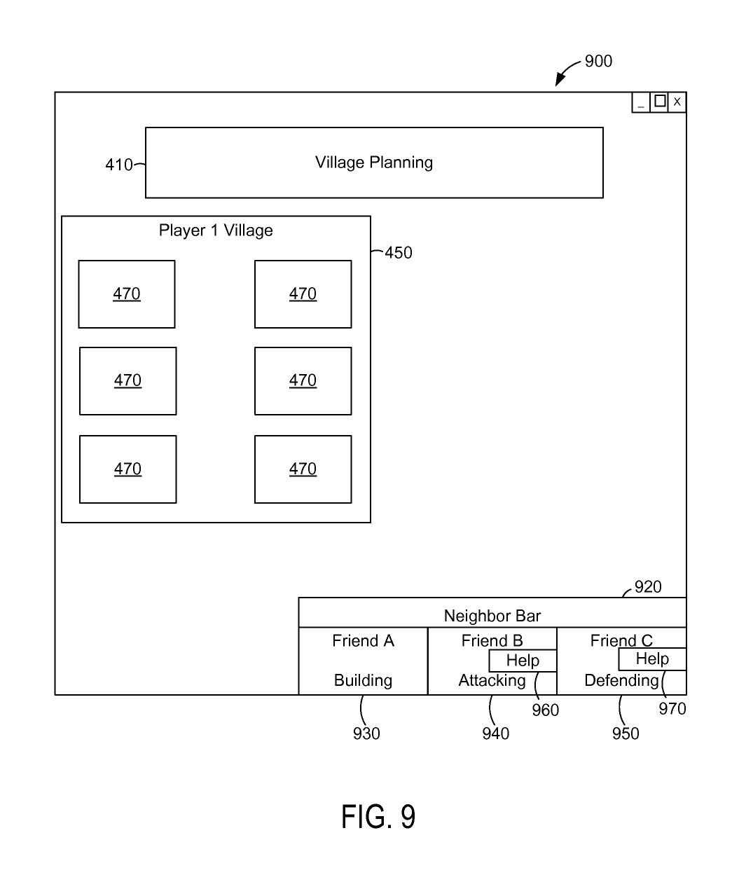

FIG. 10 is a block diagram illustrating an example user interface of an example game instance. Shown in FIG. 10 is a UI 1000 with a title 410, a notification 1020, and buttons 1030 and 1040. Also shown is the player's village 450, with buildings 470. The elements 410, 450, and 470 are as described above, with respect to FIG. 4.

The notification 1020 may appear to notify the player that an attack against the player has occurred. The notification 1020 may appear for a limited period of time, and vanish automatically if the player does not respond to it. The notification 1020 may appear while the attack is taking place, after the attack is resolved, or both.

The button 1030, labeled “Recover,” may be operable by the player to reduce the damage taken from the attack. In some example embodiments, additional UI options may be presented to the player, operable to select the type of recovery, the amount of recovery, or both. In some example embodiments, the recovery options may be associated with a cost of in-game, real-world, or premium currency. For example, the standard exchange rate between U.S. Dollars and in-game Copper may be 100 Copper for 1 U.S. Dollar. In this example, a player may be attacked and suffer damage in the amount of 100 Copper. By choosing to recover from the losses, the player may be offered a more advantageous exchange rate, e.g. 100 Copper for $0.50. In this example embodiment, the player may be given the option to select the amount of the recovery. The maximum amount of the recovery may be limited based on an attribute of the player, e.g., level, experience, wealth, guild level, or any suitable combination thereof. In some example embodiments, the player may build buildings, conduct research, spend resources or any suitable combination thereof in order to gain improved recovery options. In some example embodiments, there is no cost associated with the recovery. These embodiments may be combined, e.g., by providing a fixed amount of recovery for free along with the option to purchase additional recovery.

The button 1040, labeled “Ignore,” may be operable by the player to dismiss the notification 1020 without recovering from the attack. In some example embodiments, ignoring the notification 1020 and operating the button 1040 generate identical results. In some example embodiments, choosing to ignore the recovery option provides other benefits, such as additional game actions or an advantage (e.g., additional units, additional damage-dealing, additional defense ability, or any suitable combination thereof) in a counter-attack.

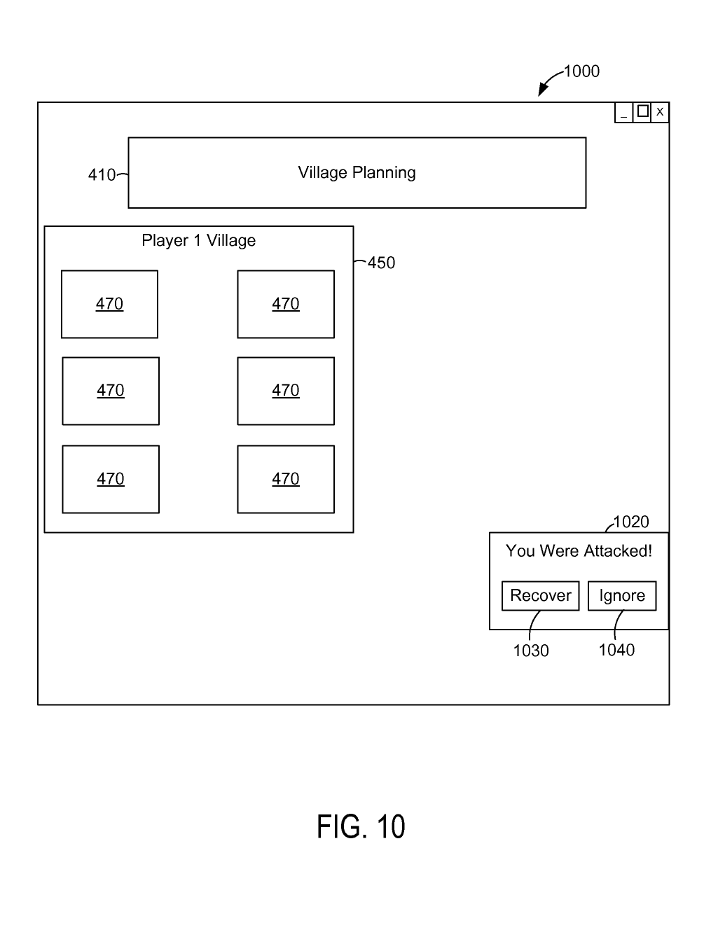

FIG. 11 is a block diagram illustrating an example user interface 1100 of an example game instance (e.g., a game instance on a mobile device). The UI 1100 includes icons 710 receiving a push notification in push notification message area 1120 with buttons 1130 and 1140. The icons 710 are described above with respect to FIG. 7.

The push notification message area 1120 may be displayed on the UI 1100 after the client system 130 receives corresponding data over the network 160. The push notification message area 1120 may include a message, such as “You Were Attacked!” and one or more buttons 1130 and 1140. In some example embodiments, the push notification may interrupt any other activity engaged in by the player. In some example embodiments, the push notification may be queued by the device for later presentation to the player.

The button 1130, labeled “Recover,” may be operable by the player to reduce the damage taken from the attack. In some example embodiments, additional UI options may be presented to the player, operable to select the type of recovery, the amount of recovery, or both. In some example embodiments, the recovery options may be associated with a cost of in-game, real-world, or premium currency. For example, the standard exchange rate between U.S. Dollars and in-game Copper may be 100 Copper for 1 U.S. Dollar. In this example, a player may be attacked and suffer damage in the amount of 100 Copper. By choosing to recover from the losses, the player may be offered a more advantageous exchange rate, e.g. 100 Copper for $0.50. In this example embodiment, the player may be given the option to select the amount of the recovery. The maximum amount of the recovery may be limited based on an attribute of the player, e.g., level, experience, wealth, guild level, or any suitable combination thereof. In some example embodiments, the player may build buildings, conduct research, spend resources or any suitable combination thereof in order to gain improved recovery options. In some example embodiments, there is no cost associated with the recovery. These embodiments may be combined, e.g., by providing a fixed amount of recovery for free along with the option to purchase additional recovery.

The button 1140, labeled “Ignore,” may be operable by the player to dismiss the notification without recovering from the attack. In some example embodiments, ignoring the notification and operating the button 1140 generate identical results. In some example embodiments, choosing to ignore the recovery option provides other benefits, such as additional game actions or an advantage (e.g., additional units, additional damage-dealing, additional defense ability, or any suitable combination thereof) in a counter-attack.

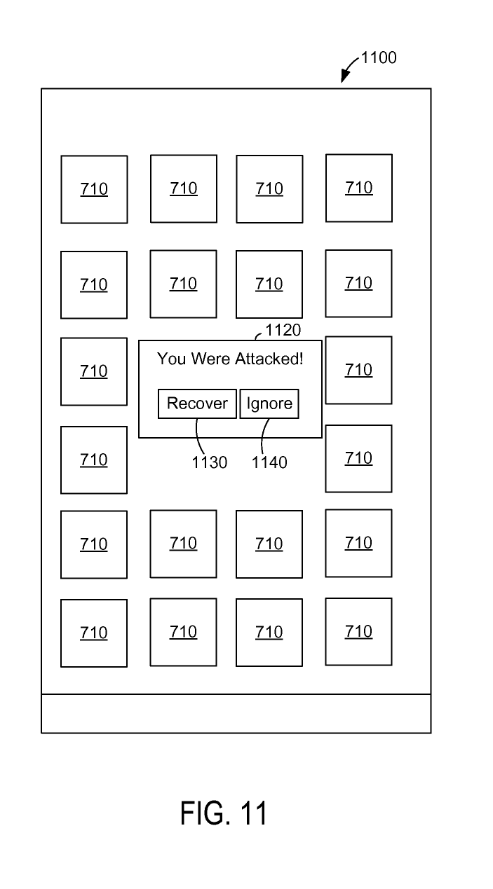

FIG. 12 is a flowchart illustrating operations of the client system 130 or the game networking system 120b in performing a method 1200 of having a player recover from an attack by another player, according to some example embodiments. Operations in the method 1200 may be performed by the client system 130 or the game networking system 120b, using modules described above with respect to FIG. 3. As shown in FIG. 12, the method 1200 includes operations 1210, 1220, 1230, 1240, and 1250.

In operation 1210, an area to attack is displayed to a first player in a UI by the display module 360 (FIG. 3A). In some example embodiments, the UI allows the first player to select attacking units, locations within the area to attack, or both.

In operation 1220, a command from the first player to attack a second player with one or more units is received by the communications module 340. In some example embodiments, the first player and the second player are members of opposing guilds. A guild may be a formal or informal organization of players, organized by the game or organized by the players.

In operation 1230, the communications module 340 notifies the second player of the attack. In some example embodiments, the second player is currently playing the game, and the notification is presented by the display module 330 as a UI element within the game. In some example embodiments, the second player is notified by a push notification, displayed to the user via the push notification framework of the user's client system 130. The second player may be notified before the attack begins, while the attack is in progress, after the attack is completed, or any suitable combination of these. As an example, the second player may be notified according to the method 1200 while the second player's guildmates or neighbors are notified according to the method 1300, which is discussed below.

In operation 1240, the communications module 340 receives a response to the attack by the second player. For example, the second player may choose to aid the first player in defending from the attack.

In operation 1250, the game engine 320 mitigates the damage done to the second player in the attack. This mitigation may take the form of restoring destroyed units, healing damaged units, repairing damaged buildings, restoring destroyed buildings, replacing lost resources, or any suitable combination thereof. The mitigation may also take the form of adding friendly units to the battle, destroying attacking units, damaging attacking units, providing an offensive bonus, providing a defensive bonus, or any suitable combination thereof. The mitigation may be free, at a reduced price, available in greater amounts than normal (e.g., if there is normally a limit of purchasing 100 Copper per day, the limit may not apply, or may apply at a reduced rate, to Copper purchased in mitigation), or any suitable combination thereof. The amount of mitigation may be determined based on one or more elements of the user status, based on one or more elements of the status of a guild the user belongs to, based on one or more elements of the attacking player's status, based on one or more elements of the status of a guild the attacking player belongs to, based on the time taken by the user in responding to the notification, or any suitable combination thereof.

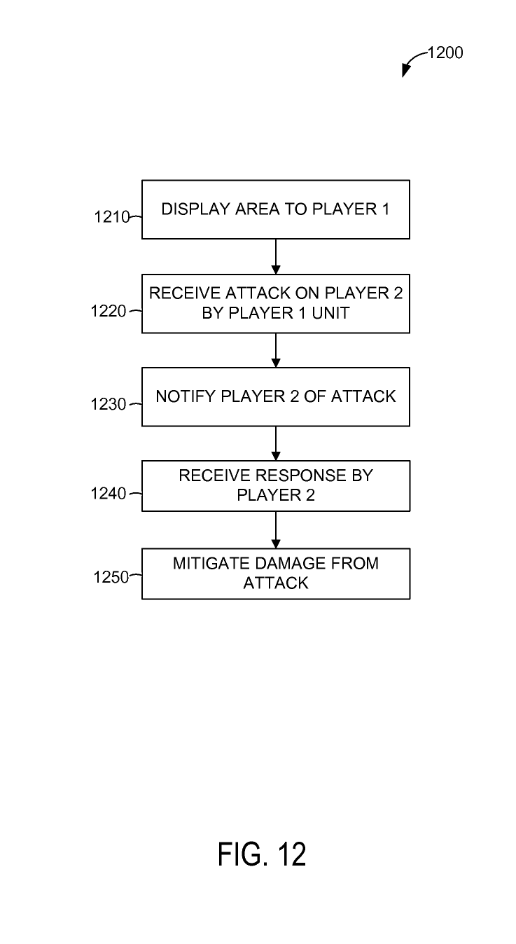

FIG. 13 is a flowchart illustrating operations of the client system 130 or the game networking system 120b in performing a method 1300 of having a third player intervene in a battle between two players, according to some example embodiments. Operations in the method 1300 may be performed by the client system 130 or the game networking system 120b, using modules described above with respect to FIGS. 3A and 3B. As shown in FIG. 13, the method 1300 includes operations 1310, 1320, 1330, 1340, and 1350.

In operation 1310, an area to attack is displayed to a first player in a UI by the display module 360. In some example embodiments, the UI allows the first player to select attacking units, locations within the area to attack, or both. In other example embodiments, the attacking units and locations to attack are automatically determined.

In operation 1320, a command from the first player to attack a second player with one or more units is received by the communications module 340. In some example embodiments, the first player and the second player are members of opposing guilds.

In operation 1330, the communications module 340 notifies a third player of the attack. In some example embodiments, the third player is currently playing the game, and the notification is presented by the display module 330 as a UI element within the game. In some example embodiments, the third player is notified by a push notification, displayed to the user via the push notification framework of the user's client system 130. In some example embodiments, the first player and the third player are members of the same guild, members of allied guilds, or both. In some example embodiments, the second player and third player are members of the same guild, members of allied guilds, or both.

In some example embodiments, players can communicate using a chat system. A chat system allows users to send text, audio, or video messages in real-time. In some example embodiments, the chat system allows users to send only text messages. The chat system may also be used by the communications module 340 to notify the third player of the attack. When the client system 130 receives the notification, the display module 330 may display the notification within the game UI. Messages within the chat system may be addressed to users using a user name and an IP address. To provide for different treatment of notification messages relative to ordinary chat messages, notification messages may be sent to the user's IP address with a different username. Alternatively or additionally, one or more of the data packets comprising the notification message may include a flag that indicates that the message is not for display in the UI of the chat system. The player's response to the notification may be sent back using the chat system, or using the communication method used for other game commands.

In operation 1340, the communications module 340 receives an intervention in the attack by the third player. In some example embodiments, the third player intervenes on behalf of the first player. In some example embodiments, the third player intervenes on behalf of the second player.

In operation 1350, the game engine 350 or the intervention module 380 adds one or more units to the battle. The units may be taken from the third player, generated based on one or more characteristics of the third player, or both. The units may be added to the attacking forces or the defending forces. In some example embodiments, rather than adding units to the battle, another type of advantage is given to the first or second player. For example, units of the aided player may deal additional damage, take less damage, move more quickly, or any suitable combination thereof. The type of advantage conferred may be based on a characteristic of the aiding player, a characteristic of the aided player, a characteristic of the attacking player, a characteristic of the aiding player's guild, a characteristic of the attacking player's guild, or any suitable combination thereof. For example, an aiding player may select an option of the type of aid to provide in a particular battle. As another example, an aiding player may research a technology that changes the type of aid provided.

According to various example embodiments, one or more of the methodologies described herein may facilitate aiding allies in a game. Moreover, one or more of the methodologies described herein may facilitate keeping players involved in the game even when not playing.

When these effects are considered in aggregate, one or more of the methodologies described herein may obviate a need for certain efforts or resources that otherwise would be involved in responding to attacks in a game. Efforts expended by a user in protecting his player character or aiding his guildmates may be reduced by one or more of the methodologies described herein. Computing resources used by one or more machines, databases, or devices (e.g., within the system 100) may similarly be reduced. Examples of such computing resources include processor cycles, network traffic, memory usage, data storage capacity, power consumption, and cooling capacity.

### Data Flow

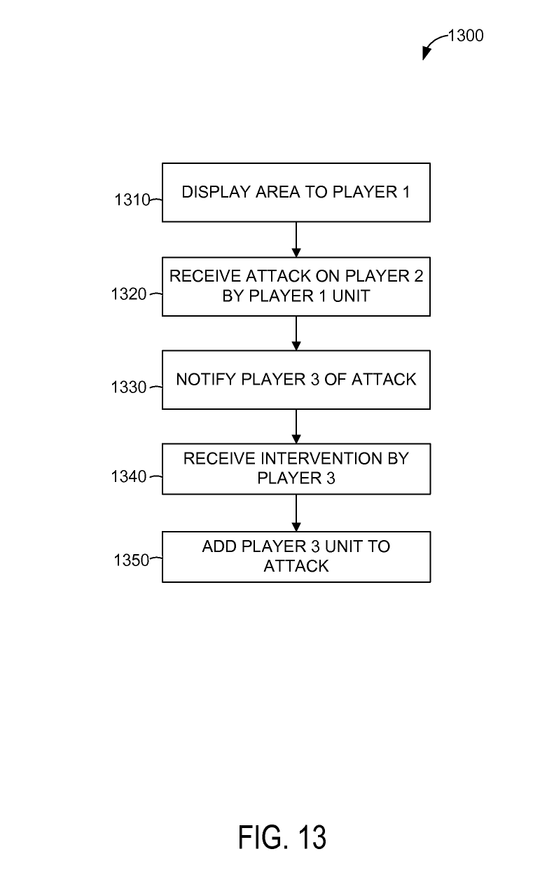

FIG. 14 illustrates an example data flow between the components of system 1400. In particular embodiments, system 1400 can include client system 1430, social networking system 1420a, and game networking system 1420b. The components of system 1400 can be connected to each other in any suitable configuration, using any suitable type of connection. The components may be connected directly or over any suitable network. Client system 1430, social networking system 1420a, and game networking system 1420b can each have one or more corresponding data stores such as local data store 1425, social data store 1445, and game data store 1465, respectively. Social networking system 1420a and game networking system 1420b can also have one or more servers that can communicate with client system 1430 over an appropriate network. Social networking system 1420a and game networking system 1420b can have, for example, one or more internet servers for communicating with client system 1430 via the Internet. Similarly, social networking system 1420a and game networking system 1420b can have one or more mobile servers for communicating with client system 1430 via a mobile network (e.g., GSM, PCS, Wi-Fi, WPAN, etc.). In some embodiments, one server may be able to communicate with client system 1430 over both the Internet and a mobile network. In other embodiments, separate servers can be used.

Client system 1430 can receive and transmit data 1423 to and from game networking system 1420b. Data 1423 can include, for example, webpages, messages, game inputs, game displays, HTTP packets, data requests, transaction information, updates, and other suitable data. At some other time, or at the same time, game networking system 1420b can communicate data 1443, 1447 (e.g., game state information, game system account information, page info, messages, data requests, updates, etc.) with other networking systems, such as social networking system 1420a (e.g., Facebook, Myspace, etc.). Client system 1430 can also receive and transmit data 1427 to and from social networking system 1420a. Data 1427 can include, for example, webpages, messages, social graph information, social network displays, HTTP packets, data requests, transaction information, updates, and other suitable data.

Communication between client system 1430, social networking system 1420a, and game networking system 1420b can occur over any appropriate electronic communication medium or network using any suitable communications protocols. For example, client system 1430, as well as various servers of the systems described herein, may include Transport Control Protocol/Internet Protocol (TCP/IP) networking stacks to provide for datagram and transport functions. Of course, any other suitable network and transport layer protocols can be utilized.

In addition, hosts or end-systems described herein may use a variety of higher layer communications protocols, including client-server (or request-response) protocols such as the HyperText Transfer Protocol (HTTP); other communications protocols, such as HTTP-S, FTP, SNMP, TELNET, and a number of other protocols, may be used. In addition, a server in one interaction context may be a client in another interaction context. In particular embodiments, the information transmitted between hosts may be formatted as HyperText Markup Language (HTML) documents. Other structured document languages or formats can be used, such as XML, and the like. Executable code objects, such as JavaScript and ActionScript, can also be embedded in the structured documents.

In some client-server protocols, such as the use of HTML over HTTP, a server generally transmits a response to a request from a client. The response may comprise one or more data objects. For example, the response may comprise a first data object, followed by subsequently transmitted data objects. In particular embodiments, a client request may cause a server to respond with a first data object, such as an HTML page, which itself refers to other data objects. A client application, such as a browser, will request these additional data objects as it parses or otherwise processes the first data object.

In particular embodiments, an instance of an online game can be stored as a set of game state parameters that characterize the state of various in-game objects, such as, for example, player character state parameters, non-player character parameters, and virtual item parameters. In particular embodiments, game state is maintained in a database as a serialized, unstructured string of text data as a so-called Binary Large Object (BLOB). When a player accesses an online game on game networking system 1420b, the BLOB containing the game state for the instance corresponding to the player can be transmitted to client system 1430 for use by a client-side executed object to process. In particular embodiments, the client-side executable may be a FLASH-based game, which can de-serialize the game state data in the BLOB. As a player plays the game, the game logic implemented at client system 1430 maintains and modifies the various game state parameters locally. The client-side game logic may also batch game events, such as mouse clicks, and transmit these events to game networking system 1420b. Game networking system 1420b may itself operate by retrieving a copy of the BLOB from a database or an intermediate memory cache (memcache) layer. Game networking system 1420b can also de-serialize the BLOB to resolve the game state parameters and execute its own game logic based on the events in the batch file of events transmitted by the client to synchronize the game state on the server side. Game networking system 1420b may then re-serialize the game state, now modified, into a BLOB and pass this to a memory cache layer for lazy updates to a persistent database.

With a client-server environment in which the online games may run, one server system, such as game networking system 1420b, may support multiple client systems 1430. At any given time, there may be multiple players at multiple client systems 1430 all playing the same online game. In practice, the number of players playing the same game at the same time may be very large. As the game progresses with each player, multiple players may provide different inputs to the online game at their respective client systems 1430, and multiple client systems 1430 may transmit multiple player inputs and/or game events to game networking system 1420b for further processing. In addition, multiple client systems 1430 may transmit other types of application data to game networking system 1420b.

In particular embodiments, a computer-implemented game may be a text-based or turn-based game implemented as a series of web pages that are generated after a player selects one or more actions to perform. The web pages may be displayed in a browser client executed on client system 1430. As an example and not by way of limitation, a client application downloaded to client system 1430 may operate to serve a set of webpages to a player. As another example and not by way of limitation, a computer-implemented game may be an animated or rendered game executable as a stand-alone application or within the context of a webpage or other structured document. In particular embodiments, the computer-implemented game may be implemented using Adobe Flash-based technologies. As an example and not by way of limitation, a game may be fully or partially implemented as a SWF object that is embedded in a web page and executable by a Flash media player plug-in. In particular embodiments, one or more described webpages may be associated with or accessed by social networking system 1420a. This disclosure contemplates using any suitable application for the retrieval and rendering of structured documents hosted by any suitable network-addressable resource or website.

Application event data of a game is any data relevant to the game (e.g., player inputs). In particular embodiments, each application datum may have a name and a value, and the value of the application datum may change (i.e., be updated) at any time. When an update to an application datum occurs at client system 1430, either caused by an action of a game player or by the game logic itself, client system 1430 may need to inform game networking system 1420b of the update. For example, if the game is a farming game with a harvest mechanic (such as Zynga FarmVille), an event can correspond to a player clicking on a parcel of land to harvest a crop. In such an instance, the application event data may identify an event or action (e.g., harvest) and an object in the game to which the event or action applies. For illustration purposes and not by way of limitation, system 1400 is discussed in reference to updating a multi-player online game hosted on a network-addressable system (such as, for example, social networking system 1420a or game networking system 1420b), where an instance of the online game is executed remotely on a client system 1430, which then transmits application event data to the hosting system such that the remote game server synchronizes game state associated with the instance executed by the client system 1430.

In a particular embodiment, one or more objects of a game may be represented as an Adobe Flash object. Flash may manipulate vector and raster graphics, and supports bidirectional streaming of audio and video. “Flash” may mean the authoring environment, the player, or the application files. In particular embodiments, client system 1430 may include a Flash client. The Flash client may be configured to receive and run Flash application or game object code from any suitable networking system (such as, for example, social networking system 1420a or game networking system 1420b). In particular embodiments, the Flash client may be run in a browser client executed on client system 1430. A player can interact with Flash objects using client system 1430 and the Flash client. The Flash objects can represent a variety of in-game objects. Thus, the player may perform various in-game actions on various in-game objects by make various changes and updates to the associated Flash objects. In particular embodiments, in-game actions can be initiated by clicking or similarly interacting with a Flash object that represents a particular in-game object. For example, a player can interact with a Flash object to use, move, rotate, delete, attack, shoot, or harvest an in-game object. This disclosure contemplates performing any suitable in-game action by interacting with any suitable Flash object. In particular embodiments, when the player makes a change to a Flash object representing an in-game object, the client-executed game logic may update one or more game state parameters associated with the in-game object. To ensure synchronization between the Flash object shown to the player at client system 1430, the Flash client may send the events that caused the game state changes to the in-game object to game networking system 1420b. However, to expedite the processing and hence the speed of the overall gaming experience, the Flash client may collect a batch of some number of events or updates into a batch file. The number of events or updates may be determined by the Flash client dynamically or determined by game networking system 1420b based on server loads or other factors. For example, client system 1430 may send a batch file to game networking system 1420b whenever 50 updates have been collected or after a threshold period of time, such as every minute.

As used herein, the term “application event data” may refer to any data relevant to a computer-implemented game application that may affect one or more game state parameters, including, for example and without limitation, changes to player data or metadata, changes to player social connections or contacts, player inputs to the game, and events generated by the game logic. In particular embodiments, each application datum may have a name and a value. The value of an application datum may change at any time in response to the game play of a player or in response to the game engine (e.g., based on the game logic). In particular embodiments, an application data update occurs when the value of a specific application datum is changed. In particular embodiments, each application event datum may include an action or event name and a value (such as an object identifier). Thus, each application datum may be represented as a name-value pair in the batch file. The batch file may include a collection of name-value pairs representing the application data that have been updated at client system 1430. In particular embodiments, the batch file may be a text file and the name-value pairs may be in string format.

In particular embodiments, when a player plays an online game on client system 1430, game networking system 1420b may serialize all the game-related data, including, for example and without limitation, game states, game events, user inputs, for this particular user and this particular game into a BLOB and stores the BLOB in a database. The BLOB may be associated with an identifier that indicates that the BLOB contains the serialized game-related data for a particular player and a particular online game. In particular embodiments, while a player is not playing the online game, the corresponding BLOB may be stored in the database. This enables a player to stop playing the game at any time without losing the current state of the game the player is in. When a player resumes playing the game next time, game networking system 1420b may retrieve the corresponding BLOB from the database to determine the most-recent values of the game-related data. In particular embodiments, while a player is playing the online game, game networking system 1420b may also load the corresponding BLOB into a memory cache so that the game system may have faster access to the BLOB and the game-related data contained therein.

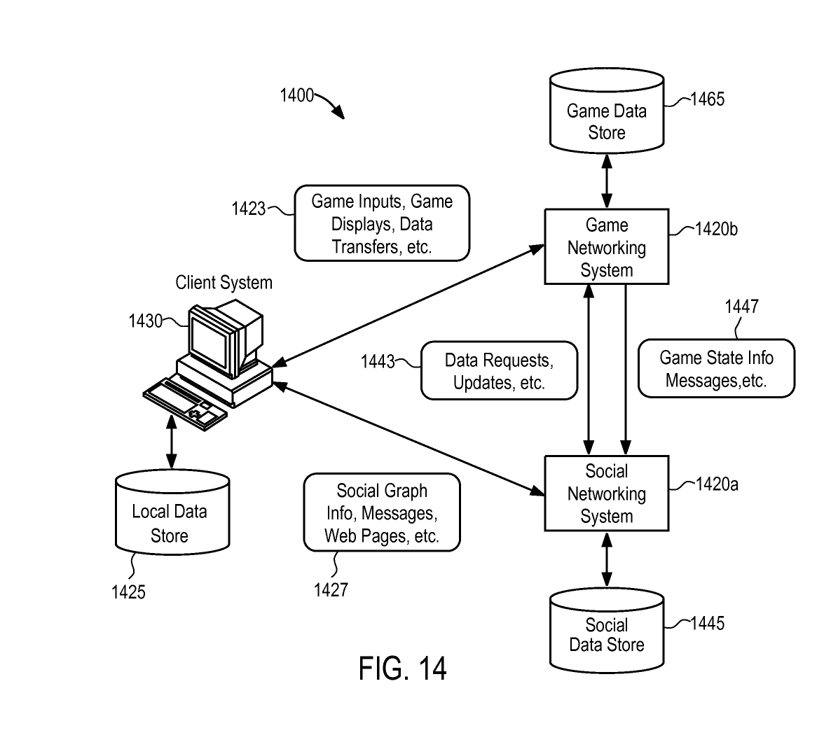

FIG. 15 is a block diagram illustrating data structures in example embodiments. Shown are data packets 1500 and 1550, with data elements 1510 -1540 and 1560-1580, respectively.

The data packet 1500 is an example command data packet used to communicate between a game client and a game server. The source 1510 indicates the source of the command 1530. For example, players in the game may have unique 32-bit identifiers. The source 1510 may be a 32-bit value containing the unique identifier for the player generating the command 1530. The target 1520 may be a 32-bit value containing the unique identifier for the target of the command 1530. For example, if the command 1530 is an attack command, the target 1520 may indicate the target of the attack. As another example, if the command 1530 is a command to give aid, the target 1520 may indicate the recipient of the aid. The parameter 1540 contains additional information for the processing of the command 1530. Multiple parameters 1540 may be present. For example, in an attack, the parameters 1540 may indicate the number and types of units dedicated to the attack. As another example, when aid is given, the parameters 1540 may indicate the amount and type of aid given.

The data packet 1550 is an example chat data packet used to communicate between a game client and a game server. The source 1560 and target 1570 may correspond to the source 1510 and target 1520 discussed above. The message 1580 contains a text string. The text string may be an ASCII string, a unicode string, or in some other character format. The text string may be compressed or uncompressed. The message 1580 may contain additional information, such as formatting information (e.g., bold text, italicized text, highlighted text, font size, color, and so on). A data packet 1550 may be addressed to a player, for display to the player. A data packet 1550 may be addressed to a game instance, for processing by the game instance. For example, the target 1570 may have one value for the player and a separate value for the player's game instance. As another example, the target 1570 may have the same value for the player and the player's game instance, but special characters in the message 1580 may be used to identify the packet 1550 as destined for processing by the player's game instance.

In some example embodiments, a game instance uses a data packet 1500 to communicate commands entered by the player to the game server and to communicate asynchronous data sent by the game server to the player. In these example embodiments, the game server may use a data packet 1550 to communicate synchronous data to the player. For example, to trigger a pop-up window in the game interface based on a real-time event, a data packet 1550 may be sent to the player or the player's game instance. The response to the pop-up window may be sent using a data packet 1500 or a data packet 1550.

### Systems and Methods

In particular embodiments, one or more described webpages may be associated with a networking system or networking service. However, alternate embodiments may have application to the retrieval and rendering of structured documents hosted by any type of network addressable resource or web site. Additionally, as used herein, a user may be an individual, a group, or an entity (such as a business or third party application).

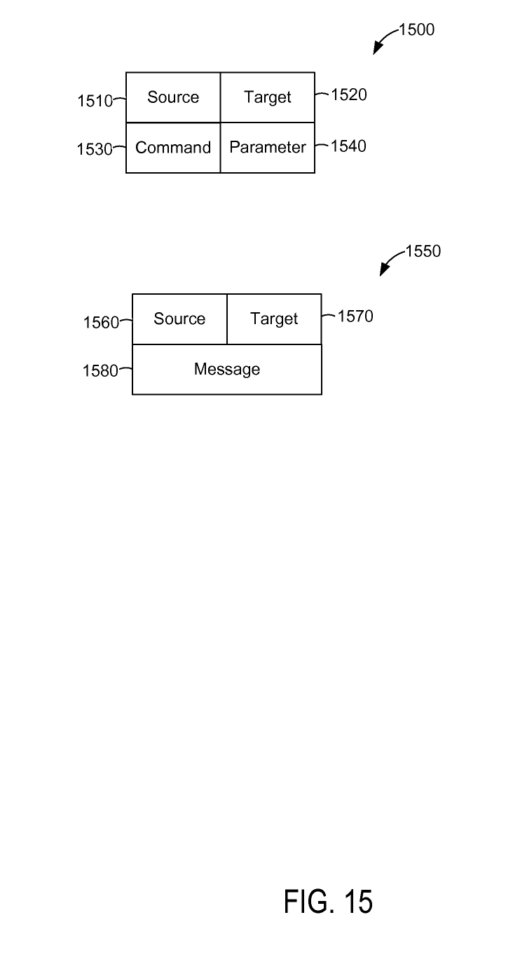

Particular embodiments may operate in a wide area network environment, such as the Internet, including multiple network addressable systems. FIG. 16 illustrates an example network environment 1600, in which various example embodiments may operate. Network cloud 1660 generally represents one or more interconnected networks, over which the systems and hosts described herein can communicate. Network cloud 1660 may include packet-based wide area networks (such as the Internet), private networks, wireless networks, satellite networks, cellular networks, paging networks, and the like. As FIG. 16 illustrates, particular embodiments may operate in a network environment 1600 comprising one or more networking systems, such as social networking system 1620a, game networking system 1620b, and one or more client systems 1630. The components of social networking system 1620a and game networking system 1620b operate analogously; as such, hereinafter they may be referred to simply as networking system 1620. Client systems 1630 are operably connected to the network environment 1600 via a network service provider, a wireless carrier, or any other suitable means.

Networking system 1620 is a network addressable system that, in various example embodiments, comprises one or more physical servers 1622 and data stores 1624. The one or more physical servers 1622 are operably connected to network cloud 1660 via, by way of example, a set of routers and/or networking switches 1626. In an example embodiment, the functionality hosted by the one or more physical servers 1622 may include web or HTTP servers, FTP servers, as well as, without limitation, webpages and applications implemented using Common Gateway Interface (CGI) script, PHP Hyper-text Preprocessor (PHP), Active Server Pages (ASP), Hyper Text Markup Language (HTML), Extensible Markup Language (XML), Java, JavaScript, Asynchronous JavaScript and XML (AJAX), Flash, ActionScript, and the like.

Physical servers 1622 may host functionality directed to the operations of networking system 1620. Hereinafter servers 1622 may be referred to as server 1622, although server 1622 may include numerous servers hosting, for example, networking system 1620, as well as other content distribution servers, data stores, and databases. Data store 1624 may store content and data relating to, and enabling, operation of networking system 1620 as digital data objects. A data object, in particular embodiments, is an item of digital information typically stored or embodied in a data file, database, or record. Content objects may take many forms, including: text (e.g., ASCII, SGML, HTML), images (e.g., jpeg, tif and gif), graphics (vector-based or bitmap), audio, video (e.g., mpeg), or other multimedia, and combinations thereof. Content object data may also include executable code objects (e.g., games executable within a browser window or frame), podcasts, etc. Logically, data store 1624 corresponds to one or more of a variety of separate and integrated databases, such as relational databases and object-oriented databases, that maintain information as an integrated collection of logically related records or files stored on one or more physical systems. Structurally, data store 1624 may generally include one or more of a large class of data storage and management systems. In particular embodiments, data store 1624 may be implemented by any suitable physical system(s) including components, such as one or more database servers, mass storage media, media library systems, storage area networks, data storage clouds, and the like. In one example embodiment, data store 1624 includes one or more servers, databases (e.g., MySQL), and/or data warehouses. Data store 1624 may include data associated with different networking system 1620 users and/or client systems 1630.

Client system 1630 is generally a computer or computing device including functionality for communicating (e.g., remotely) over a computer network. Client system 1630 may be a desktop computer, laptop computer, personal digital assistant (PDA), in- or out-of-car navigation system, smart phone or other cellular or mobile phone, or mobile gaming device, among other suitable computing devices. Client system 1630 may execute one or more client applications, such as a web browser (e.g., Microsoft Internet Explorer, Mozilla Firefox, Apple Safari, Google Chrome, and Opera), to access and view content over a computer network. In particular embodiments, the client applications allow a user of client system 1630 to enter addresses of specific network resources to be retrieved, such as resources hosted by networking system 1620. These addresses can be Uniform Resource Locators (URLs) and the like. In addition, once a page or other resource has been retrieved, the client applications may provide access to other pages or records when the user “clicks” on hyperlinks to other resources. By way of example, such hyperlinks may be located within the webpages and provide an automated way for the user to enter the URL of another page and to retrieve that page.

A webpage or resource embedded within a webpage, which may itself include multiple embedded resources, may include data records, such as plain textual information, or more complex digitally encoded multimedia content, such as software programs or other code objects, graphics, images, audio signals, videos, and so forth. One prevalent markup language for creating webpages is the Hypertext Markup Language (HTML). Other common web browser-supported languages and technologies include the Extensible Markup Language (XML), the Extensible Hypertext Markup Language (XHTML), JavaScript, Flash, ActionScript, Cascading Style Sheet (CSS), and, frequently, Java. By way of example, HTML enables a page developer to create a structured document by denoting structural semantics for text and links, as well as images, web applications, and other objects that can be embedded within the page. Generally, a webpage may be delivered to a client as a static document; however, through the use of web elements embedded in the page, an interactive experience may be achieved with the page or a sequence of pages. During a user session at the client, the web browser interprets and displays the pages and associated resources received or retrieved from the website hosting the page, as well as, potentially, resources from other websites.

When a user at a client system 1630 desires to view a particular webpage (hereinafter also referred to as target structured document) hosted by networking system 1620, the user's web browser, or other document rendering engine or suitable client application, formulates and transmits a request to networking system 1620. The request generally includes a URL or other document identifier as well as metadata or other information. By way of example, the request may include information identifying the user, such as a user ID, as well as information identifying or characterizing the web browser or operating system running on the user's client system 1630. The request may also include location information identifying a geographic location of the user's client system 1630 or a logical network location of the user's client system 1630. The request may also include a timestamp identifying when the request was transmitted.

Although the example network environment 1600 described above and illustrated in FIG. 16 is described with respect to social networking system 1620a and game networking system 1620b, this disclosure encompasses any suitable network environment using any suitable systems. As an example and not by way of limitation, a network environment may include online media systems, online reviewing systems, online search engines, online advertising systems, or any combination of two or more such systems.

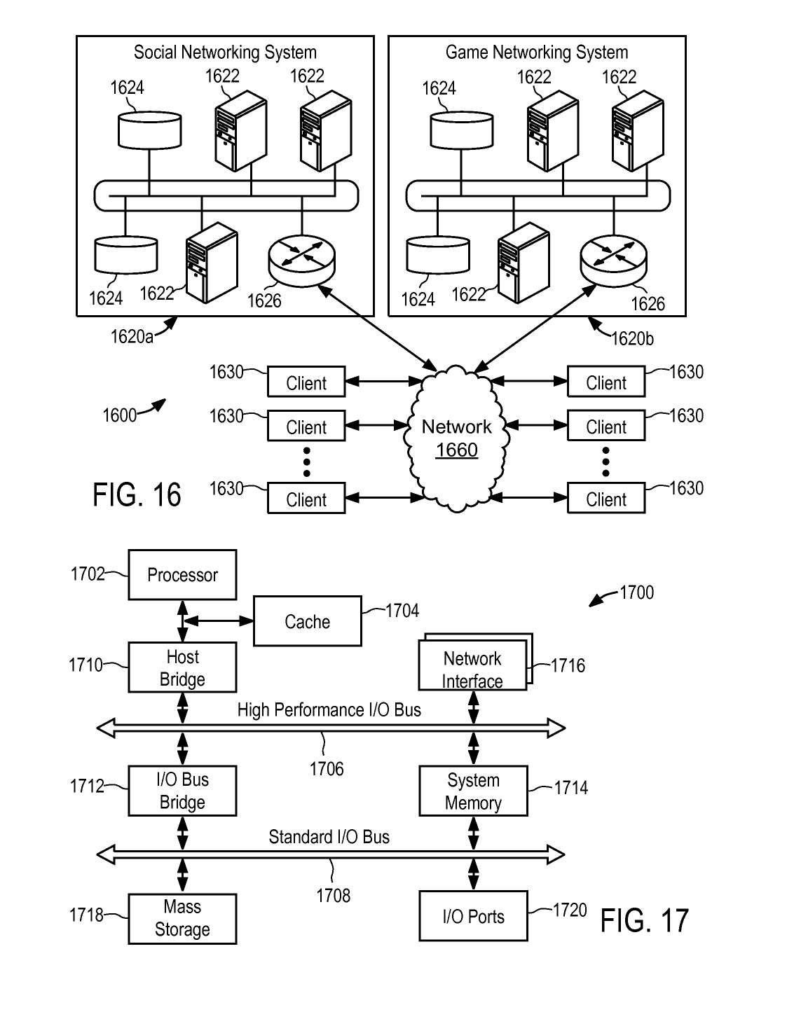

FIG. 17 illustrates an example computing system architecture, which may be used to implement a server 1622 or a client system 1630. In one embodiment, hardware system 1700 comprises a processor 1702, a cache memory 1704, and one or more executable modules and drivers, stored on a tangible computer readable medium, directed to the functions described herein. Additionally, hardware system 1700 may include a high performance input/output (I/O) bus 1706 and a standard I/O bus 1708. A host bridge 1710 may couple processor 1702 to high performance I/O bus 1706, whereas I/O bus bridge 1712 couples the two buses 1706 and 1708 to each other. A system memory 1714 and one or more network/communication interfaces 1716 may couple to bus 1706. Hardware system 1700 may further include video memory (not shown) and a display device coupled to the video memory. Mass storage 1718 and I/O ports 1720 may couple to bus 1708. Hardware system 1700 may optionally include a keyboard, a pointing device, and a display device (not shown) coupled to bus 1708. Collectively, these elements are intended to represent a broad category of computer hardware systems, including but not limited to general purpose computer systems based on the x86-compatible processors manufactured by Intel Corporation of Santa Clara, Calif., and the x86-compatible processors manufactured by Advanced Micro Devices (AMD), Inc., of Sunnyvale, Calif., as well as any other suitable processor.

The elements of hardware system 1700 are described in greater detail below. In particular, network interface 1716 provides communication between hardware system 1700 and any of a wide range of networks, such as an Ethernet (e.g., IEEE 802.3) network, a backplane, etc. Mass storage 1718 provides permanent storage for the data and programming instructions to perform the above-described functions implemented in servers 1622, whereas system memory 1714 (e.g., DRAM) provides temporary storage for the data and programming instructions when executed by processor 1702. I/O ports 1720 are one or more serial and/or parallel communication ports that provide communication between additional peripheral devices, which may be coupled to hardware system 1700.

Hardware system 1700 may include a variety of system architectures and various components of hardware system 1700 may be rearranged. For example, cache memory 1704 may be on-chip with processor 1702. Alternatively, cache memory 1704 and processor 1702 may be packed together as a “processor module,” with processor 1702 being referred to as the “processor core.” Furthermore, certain embodiments of the present disclosure may neither require nor include all of the above components. For example, the peripheral devices shown coupled to standard I/O bus 1708 may couple to high performance I/O bus 1706. In addition, in some embodiments, only a single bus may exist, with the components of hardware system 1700 being coupled to the single bus. Furthermore, hardware system 1700 may include additional components, such as additional processors, storage devices, or memories.

An operating system manages and controls the operation of hardware system 1700, including the input and output of data to and from software applications (not shown). The operating system provides an interface between the software applications being executed on the system 1700 and the hardware components of the system 1700. Any suitable operating system may be used, such as the LINUX Operating System, the Apple Macintosh Operating System, available from Apple Computer Inc. of Cupertino, Calif., UNIX operating systems, Microsoft® Windows® operating systems, BSD operating systems, and the like. Of course, other embodiments are possible. For example, the functions described herein may be implemented in firmware or on an application-specific integrated circuit.

Furthermore, the above-described elements and operations can be comprised of instructions that are stored on non-transitory storage media. The instructions can be retrieved and executed by a processing system. Some examples of instructions are software, program code, and firmware. Some examples of non-transitory storage media are memory devices, tape, disks, integrated circuits, and servers. The instructions are operational when executed by the processing system to direct the processing system to operate in accord with the disclosure. The term “processing system” refers to a single processing device or a group of inter-operational processing devices. Some examples of processing devices are integrated circuits and logic circuitry. Those skilled in the art are familiar with instructions, computers, and storage media.

As used herein, the term “memory” refers to a machine-readable medium able to store data temporarily or permanently and may be taken to include, but not be limited to, random-access memory (RAM), read-only memory (ROM), buffer memory, flash memory, and cache memory. While the data store 1624 is an example of a machine-readable medium and is shown in an example embodiment to be a single medium, the term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of storing instructions for execution by a machine (e.g., hardware system 1700), such that the instructions, when executed by one or more processors of the machine (e.g., processor 1702), cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” shall accordingly be taken to include, but not be limited to, one or more data repositories in the form of a solid-state memory, an optical medium, a magnetic medium, or any suitable combination thereof.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, a processor being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface (API)).

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of the subject matter discussed herein may be presented in terms of algorithms or symbolic representations of operations on data stored as bits or binary digital signals within a machine memory (e.g., a computer memory). Such algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

What is claimed is:

1. A method comprising:
receiving, using a processor of a machine, a game action of a first player, the game action of the first player generated by a client system of the first player, the game action of the first player directed to a target player;
causing a notification to be presented to a second player at a client system of the second player, the notification including a specification of the game action of the first player, the second player being the target player, the notification including a user interface element operable to generate a game action of the second player;
receiving the game action of the second player, responsive to the notification; and
at least in part based on whether the game action of the second player was sent within a predetermined time period, determining an outcome of the game action of the first player.

2. The method of claim 1, wherein the causing of the notification to be presented to the second player includes sending a push notification to the second player.

3. The method of claim 1, wherein the notification is received at a notification process executing on the client system of the second player, the notification process configured to provide the second player with a lightweight user interface corresponding to a game, the notification process executing independently of game processes associated with that game, the game processes configured to provide the second player with heavyweight user interfaces corresponding to the game.

4. The method of claim 1, wherein the determining of the outcome of the game action of the first player is at least in part based on whether the game action of the second player was received within the predetermined time period.

5. The method of claim 1, further comprising deducting resources from the second player, responsive to receiving the notification.

6. The method of claim 1, wherein the game action of the first player is an attack on the second player.

7. The method of claim 6, further comprising:
determining a mitigation amount based on an attribute of the second player;
determining a damage dealt to the target player based on an attribute of the first player; and
determining a damage dealt to the first player based on an attribute of the target player and the mitigation amount.

8. The method of claim 6, further comprising:
determining a damage dealt to the target player based on an attribute of the first player;
determining a damage dealt to the target player based on an attribute of the second player; and
determining a damage dealt to the first player based on an attribute of the target player.

9. The method of claim 1, wherein the first player and the second player are members of a guild.

10. The method of claim 1, further comprising:
transmitting a game state of the second player to the client system of the second player; and
transmitting the notification including the specification of the game action of the first player to the client system of the second player.

11. The method of claim 10, wherein:
the transmitting of the game state of the second player uses a first communication channel; and
the transmitting of the notification including the specification of the game action of the first player uses a second communication channel, the second communication channel being a chat channel.

12. The method of claim 11, wherein the first player and the second player are able to chat via the chat channel using a chat interface.

13. The method of claim 12, wherein the transmitting of the notification including the specification of the game action of the first player is not presented to the second player in the chat interface.

14. A system comprising:
one or more modules configured to:
receive a game action of a first player, the game action of the first player generated by a client system of the first player, the game action of the first player directed to a target player;
cause a notification to be presented to a second player at a client system of the second player, the notification including a specification of the game action of the first player, the second player being the target player, the notification including a user interface element operable to generate a game action of the second player;
receive the game action of the second player, responsive to the notification; and
at least in part based on whether the game action of the second player was sent within a predetermined time period, determine an outcome of the game action of the first player.

15. The system of claim 14, wherein the one or more modules are configured to cause the notification to be presented to the second player at least in part by sending a push notification to the second player.

16. The system of claim 14, wherein the notification is received at a notification process executing on the client system of the second player, the notification process configured to provide the second player with a lightweight user interface corresponding to a game, the notification process executing independently of game processes associated with that game, the game processes configured to provide the second player with heavyweight user interfaces corresponding to the game.

17. The system of claim 14, wherein the one or more modules are configured to determine the outcome of the game action of the first player at least in part based on whether the game action of the second player was received within the predetermined time period.

18. The system of claim 14, wherein the one or more modules are further configured to deduct resources from the second player, responsive to receiving the notification.

19. The system of claim 14, wherein the game action of the first player is an attack on the second player.

20. A non-transitory machine-readable storage medium comprising instructions that, when executed by one or more processors of a machine, cause the machine to perform operations comprising:
receiving, using a processor of the machine, a game action of a first player, the game action of the first player generated by a client system of the first player, the game action of the first player directed to a target player;
causing a notification to be presented to a second player at a client system of the second player, the notification including a specification of the game action of the first player, the second player being the target player, the notification including a user interface element operable to generate a game action of the second player;
receiving the game action of the second player, responsive to the notification; and
at least in part based on whether the game action of the second player was sent within a predetermined time period, determining an outcome of the game action of the first player.
